(19) United States
(12) Patent Application Publication
(10) Pub. No.: US 2023/0080733 A1
(43) Pub. Date: Mar. 16, 2023

(54) USER EQUIPMENT AND METHOD FOR SMALL DATA TRANSMISSION PROCEDURE

(71) Applicant: FG Innovation Company Limited, Tuen Mun (HK)

(72) Inventors: MING-HUNG TAO, Taipei (TW); HSIN-HSI TSAI, Taipei (TW); YUNG-LAN TSENG, Taipei (TW)

(21) Appl. No.: 17/898,763

(22) Filed: Aug. 30, 2022

Related U.S. Application Data
(60) Provisional application No. 63/240,735, filed on Sep. 3, 2021.

(51) Int. Cl. H04W 76/27

(52) U.S. Cl. CPC H04W 76/27

(57) ABSTRACT

A method and a user equipment (UE) for performing a Small Data Transmission (SDT) procedure are provided. The method includes transmitting, to a Base Station (BS), a Radio Resource Control (RRC) resume request message when initiating the SDT procedure; starting a timer upon transmitting the RRC resume request message; and transmitting, to the BS, UE assistance information to provide a non-SDT data indication when the timer is running.

### CROSS-REFERENCE TO RELATED APPLICATION(S)

The present disclosure claims the benefit of and priority to U.S. Provisional Patent Application Ser. No. 63/240,735, filed on Sep. 3, 2021, entitled “HANDLING OF THE NON-SDT TRAFFIC ARRIVAL,” the content of which is hereby incorporated fully by reference herein into the present disclosure for all purposes.

### FIELD

The present disclosure is related to wireless communication and, more specifically, to a Small Data Transmission (SDT) procedure in a wireless communication system.

### BACKGROUND

Various efforts have been made to improve different aspects of wireless communication for cellular wireless communication systems, such as fifth-generation (5G) New Radio (NR), by improving data rate, latency, reliability, and mobility in these systems. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art, such as improvements of a Small Data Transmission (SDT) procedure for wireless communication.

### SUMMARY

The present disclosure is related to a Small Data Transmission (SDT) procedure in a wireless communication system.

In a first aspect of the present disclosure, a method performed by a User Equipment (UE) for a Small Data Transmission (SDT) procedure is provided. The method includes transmitting, to a Base Station (BS), a Radio Resource Control (RRC) resume request message when initiating the SDT procedure; starting a timer upon transmitting the RRC resume request message; and transmitting, to the BS, UE assistance information to provide a non-SDT data indication when the timer is running.

In an implementation of the first aspect, the timer is a T319a timer.

In an implementation of the first aspect, the method further includes stopping the timer upon reception of an RRC resume message.

In an implementation of the first aspect, the method further includes stopping the timer upon reception of an RRC setup message.

In an implementation of the first aspect, the method further includes stopping the timer upon reception of an RRC reject message.

In an implementation of the first aspect, the UE assistance information is included in a UL-DCCH-MessageType Information Element (IE).

In an implementation of the first aspect, the non-SDT data indication is included in the UE assistance information.

In an implementation of the first aspect, the SDT procedure is initiated, by the UE, when the UE is in an RRC_INACTIVE state.

In a second aspect of the present disclosure, a UE in a wireless communication system for performing a Small Data Transmission (SDT) procedure is provided. The UE includes at least one processor; and at least one memory coupled to the at least one processor, wherein the at least one memory stores a computer-executable program that, when executed by the at least one processor, causes the UE to transmit, to a Base Station (BS), a Radio Resource Control (RRC) resume request message when initiating the SDT procedure; start a timer upon transmitting the RRC resume request message; and transmit, to the BS, UE assistance information to provide a non-SDT data indication when the timer is running.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 illustrates a communication diagram of a UE from an RRC_INACTIVE state to an RRC_CONNECTED state if the UE context retrieval is successful, according to an example implementation of the present disclosure.

FIG. 2 illustrates a communication diagram of a UE triggering a Radio Access Network (RAN) Notification Area (RNA) update procedure with a UE context, according to an example implementation of the present disclosure.

FIG. 3 illustrates a communication diagram of a periodic RNA update procedure without a UE context, according to an example implementation of the present disclosure.

FIG. 4 illustrates a communication diagram of a Random Access Channel (RACH)-based SDT procedure, according to an example implementation of the present disclosure.

FIG. 5 illustrates a communication diagram of a Configured Grant (CG)-based SDT procedure, according to an example implementation of the present disclosure.

FIG. 6 illustrates a communication diagram of an SDT procedure with subsequent data transmission without timer restarting condition(s), according to an example implementation of the present disclosure.

FIG. 7 illustrates a communication diagram of an SDT procedure with subsequent data transmission timer restarting condition(s), according to an example implementation of the present disclosure.

FIG. 8 illustrates a communication diagram of an exemplary procedure specifying the issues for the UE/Network (NW) upon the UE detecting the arrival of non-SDT data, according to an example implementation of the present disclosure.

FIG. 9 illustrates a diagram of a full-I-RNTI MAC CE and a short-I-RNTI MAC CE, according to an example implementation of the present disclosure.

FIG. 10 illustrates a diagram of a resumeMAC-I MAC CE, according to an example implementation of the present disclosure.

FIG. 11 illustrates a flowchart of a procedure performed by a UE for the SDT procedure, according to an example implementation of the present disclosure.

FIG. 12 is a block diagram illustrating a node for wireless communication, according to an example implementation of the present disclosure.

### DESCRIPTION

Abbreviations used in this disclosure include:

| Abbreviation | Full name |
|---|---|
| 3GPP | 3^{rd} Generation Partnership Project |
| 5GC | 5G Core Network |
| AMF | Access and Mobility Management Function |
| AP | Application Protocol |
| AS | Access Stratum |
| BS | Base Station |
| BSR | Buffer Status Report |
| BWP | Bandwidth Part |
| CBRA | Contention-Based Random Access |
| CCCH | Common Control Channel |
| CE | Control Element |
| CFRA | Contention-Free Random Access |
| CG | Configured Grant |
| CM | Connection Management |
| CN | Core Network |
| CORESET | Control Resource Set |
| C-RNTI | Cell-Radio Network Temporary Identifier |
| CS-RNTI | Configured Scheduling-Radio Network Temporary |
| | Identifier |
| CSI | Channel State Information |
| CSS | Common Search Space |
| CP | Cyclic Prefix |
| DCCH | Dedicated Control Channel |
| DL | Downlink |
| DRB | Data Radio Bearer |
| DRX | Discontinuous Reception |
| eNB | Evolved Node B |
| gNB | Next Generation Node B |
| HARQ | Hybrid Automatic Repeat Request |
| ID | Identifier/Identity |
| IE | Information Element |
| IM | Instant Message |
| I-RNTI | Inactive-Radio Network Temporary Identifier |
| LCP | Logical Channel Prioritization |
| MAC | Medium Access Control |
| MCG | Master Cell Group |
| MN | Master Node |
| MO | Mobile-Originated |
| MSG | Message |
| MT | Mobile-Terminated |
| NAS | Non-Access Stratum |
| NG | Next-Generation |
| NG-RAN | Next-Generation Radio Access Network |
| NR | New Radio |
| NW | Network |
| NUL | Normal Uplink |
| OFDM | Orthogonal Frequency Division Multiplexing |
| PBCH | Physical Broadcast Channel |
| PCell | Primary Cell |
| PCI | Physical Cell Identity |
| PDCCH | Physical Downlink Control Channel |
| PDSCH | Physical Downlink Shared Channel |
| PDU | Protocol Data Unit |
| PHR | Power Headroom Reporting |
| PHY | Physical Layer |
| PLMN | Public Land Mobile Network |
| PRACH | Physical Random Access Channel |
| PSCell | Primary Secondary Cell |
| PUCCH | Physical Uplink Control Channel |
| PUSCH | Physical Uplink Shared Channel |
| RA | Random Access |
| RA-SDT | Random Access Based Procedure for Small Data |
| | Transmission |
| RA-RNTI | Random Access-Radio Network Temporary Identifier |
| RACH | Random Access Channel |
| RAR | Random Access Response |
| RAN | Radio Access Network |
| Rel | Release |
| RLC | Radio Link Control |
| RNA | RAN-Based Notification Area |
| RNAU | RAN-Based Notification Area Update |
| RNTI | Radio Network Temporary Identifier |
| RO | RACH Occasion |
| RRC | Radio Resource Control |
| RRM | Radio Resource Management |
| RS | Reference Signal |
| RSRP | Reference Signal Received Power |
| RSRQ | Reference Signal Received Quality |
| SCell | Secondary Cell |
| SCG | Secondary Cell Group |
| SDT | Small Data Transmission |
| SDU | Service Data Unit |
| SI | System Information |
| SIB | System Information Block |
| SL | Sidelink |
| SN | Secondary Node |
| SRB | Signaling Radio Bearer |
| SRS | Sounding Reference Signal |
| SpCell | Special Cell |
| SS | Search Space |
| SSB | Synchronization Signal and PBCH Block |
| TA | Timing Advance |
| TAC | Tracking Area Code |
| TBS | Transport Block Size |
| TS | Technical Specification |
| UE | User Equipment |
| UL | Uplink |
| UPF | User Plane Function |
| USS | UE-specific Search Space |
| URLLC | Ultra-Reliable and Low Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the so-disclosed combination, group, series, or equivalent. The expression “at least one of A, B and C”, “at least one of A, B or C” or “at least one of the following: A, B and C” means “only A, or only B, or only C, or any combination of A, B and C.”

The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may include computer-executable instructions stored on computer-readable media, such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Application-Specific Integrated Circuits (ASICs), programmable logic arrays, and/or using one or more Digital Signal Processor (DSPs). Although some of the example implementations in the present disclosure are directed to software installed and executing on computer hardware, alternative example implementations implemented as firmware, as hardware, or as a combination of hardware and software are well within the scope of the present disclosure.

The computer-readable medium includes, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long-Term Evolution (LTE) system, an LTE-Advanced (LTE-A) system, or an LTE-Advanced Pro system) typically includes at least one BS, at least one UE, and one or more optional NW elements that provide connection towards an NW. The UE communicates with the NW (e.g., a CN, an Evolved Packet Core (EPC) NW, an Evolved Universal Terrestrial Radio Access NW (E-UTRAN), a Next-Generation Core (NGC), a 5G Core (5GC) Network or an Internet), through a RAN established by the BS/Cell.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but is not limited to, a Node B (NB) as in the Universal Mobile Telecommunication System (UMTS), an eNB as in the LTE-A, a Radio NW Controller (RNC) as in the UMTS, a Base Station Controller (BSC) as in the Global System for Mobile communications (GSM)/GSM EDGE (Enhanced Data rates for GSM Evolution) Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

ABS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), LTE-A Pro, and a next generation RAT. However, the scope of the present disclosure should not be limited to the protocols previously disclosed.

The BS may be operable to provide radio coverage to a specific geographical area using a plurality of cells included in the RAN. The BS may support the operations of the cells. Each cell is operable to provide services to at least one UE within its radio coverage. More specifically, each cell (often referred to as a serving cell) may provide services to serve one or more UEs within its radio coverage (e.g., each cell schedules the DL and optionally UL resources to at least one UE within its radio coverage for DL and optionally UL packet transmissions). The BS may communicate with one or more UEs in the radio communication system through the plurality of cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or an SCG may be called a SpCell. A PCell may refer to the SpCell of an MCG. A PSCell may refer to the SpCell of an SCG. MCG refers to a group of serving cells associated with an MN, including the SpCell and optionally one or more SCells. SCG refers to a group of serving cells associated with a Secondary Node (SN), including the SpCell and optionally one or more SCells.

In some implementations, the UE may not have (LTE/NR) RRC connections with the concerned serving cells of the associated services. In other words, the UE may not have UE-specific RRC signal exchange with the serving cell. Instead, the UE may only monitor the DL synchronization signals (e.g., DL synchronization burst sets) and/or broadcast SI related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR supports flexible configurations for accommodating various next generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the CP, may also be used. Additionally, two coding schemes are considered for NR: (1) low-density parity-check (LDPC) code and (2) polar code. The coding scheme adaption may be configured based on the channel conditions and/or service applications.

It is also considered that in a transmission time interval of a single NR frame, at least DL transmission data, a guard period, and UL transmission data should be included. The respective portions of the DL transmission data, the guard period, and the UL transmission data should also be configurable, for example, based on the NW dynamics of NR. In addition, SL resources may also be provided in an NR frame to support ProSe services.

Any two or more than two of the following sentences, paragraphs, (sub)-bullets, points, actions, behaviors, terms, alternatives, aspects, examples, or claims described in the following disclosure may be combined logically, reasonably, and properly to form a specific method.

Any sentence, paragraph, (sub)-bullet, point, action, behaviors, terms, alternatives, aspects, examples, or claims described in the following disclosure may be implemented independently and separately to form a specific method.

Dependency, such as “based on”, “more specifically”, “preferably”, “in one embodiment”, “in one alternative”, “in one example”, “in one aspect”, “in one implementation”, etc., in the present disclosure is just one possible example which would not restrict the specific method.

Examples of some selected terms are provided as follows.

Anchor gNB: May include, but is not limited to, the gNB that transitions a UE into an RRC_INACTIVE state and keeps UE context(s) of that UE. This term is defined from the UE's perspective.

CORESET #0: May include, but is not limited to, the control resource set for at least an SIB1 scheduling, and may be configured via either a MIB or a dedicated RRC signaling.

gNB: May include, but is not limited to, the node that provides NR user plane and control plane protocol terminations towards the UE and may be connected via the NG interface to the 5GC.

MSG1: May include, but is not limited to, the preamble transmission of an RA procedure.

MSG3: May include, but is not limited to, the first scheduled transmission of the RA procedure.

MSGA: May include, but is not limited to, the preamble and payload transmissions of the RA procedure for a 2-step RA type.

MSGB: May include, but is not limited to, the response to a MSGA in the 2-step RA procedure. This term may include response(s) for contention resolution, fallback indication(s), and backoff indication.

Ng-eNB: May include, but is not limited to, the node that provides E-UTRA user plane and control plane protocol terminations towards the UE and may be connected via the NG interface to the 5GC.

NG-RAN node: May include, but is not limited to, the gNB or the ng-eNB.

Serving gNB: May include, but is not limited to, the gNB where the UE is currently camping on. This term is defined from the UE's perspective.

Xn: May be an NW interface between NG-RAN nodes.

UE Mobility in RRC_INACTIVE state

In some implementations, the RRC_INACTIVE state is a state where a UE may remain in a CM-CONNECTED state and may move within an area that is configured by an NG-RAN (the RNA) without notifying the NG-RAN. In the RRC_INACTIVE state, the last serving gNB node may keep the UE context and a UE-associated NG connection with the serving AMF and UPF.

In some implementations, if the last serving gNB receives DL data from the UPF or DL UE-associated signaling from the AMF (except the UE Context Release Command message) while the UE is in the RRC_INACTIVE state, the last serving gNB may page in the cells that correspond to the RNA and may send an Xn Application Protocol (XnAP) RAN Paging to neighbor gNB(s) if the RNA includes the cells of the neighbor gNB(s).

In some implementations, upon receiving the UE Context Release Command message while the UE is in the RRC_INACTIVE state, the last serving gNB may page in the cells that correspond to the RNA and may send the XnAP RAN Paging to neighbor gNB(s) if the RNA includes the cells of the neighbor gNB(s), in order to release the UE explicitly.

In some implementations, upon receiving the NG RESET message while the UE is in the RRC_INACTIVE state, the last serving gNB may page involved UEs in the cells that correspond to the RNA and may send the XnAP RAN Paging to neighbor gNB(s) if the RNA includes the cells of the neighbor gNB(s), in order to explicitly release the involved UEs.

In some implementations, if the UE accesses a gNB other than the last serving gNB, the receiving gNB may trigger the XnAP Retrieve UE Context procedure to get the UE context from the last serving gNB and may also trigger an Xn User plane (Xn-U) Address Indication procedure including tunnel information for potential recovery of data from the last serving gNB. Upon successful UE context retrieval, the receiving gNB may perform a slice-aware admission control in the case of receiving slice information and may become the serving gNB to trigger an NG Application Protocol (NGAP) Path Switch Request and applicable RRC procedures. After the NGAP Path Switch Request and applicable RRC procedures, the serving gNB may trigger release of the UE context at the last serving gNB by means of the XnAP UE Context Release procedure.

In some implementations, if the UE accesses a gNB other than the last serving gNB and the receiving gNB does not find a valid UE Context, the receiving gNB may perform establishment of a new RRC connection instead of resumption of the previous RRC connection. The UE context retrieval may also fail such that a new RRC connection may need to be established if the serving AMF changes.

In some implementations, a UE in the RRC_INACTIVE state is required to initiate an RNA update procedure when the UE moves out of a configured RNA. When a gNB receives an RNA update request from the UE, the receiving gNB may trigger the XnAP Retrieve UE Context procedure to get the UE context from the last serving gNB and may decide to have the UE transition to the RRC_INACTIVE state, transition the UE to the RRC_CONNECTED state, or transition the UE to the RRC_IDLE state. In the case of a periodic RNA update, if the last serving gNB decides not to relocate the UE context, the last serving gNB may fail the Retrieve UE Context procedure and have the UE transition to the RRC_INACTIVE state, or to RRC_IDLE state directly by an encapsulated RRCRelease message.

In some implementations, a UE in the RRC_INACTIVE state may be configured by the last serving NG-RAN node with an RNA, where:

the RNA may cover a single cell or multiple cells, and may be included within the CN registration area; in this release, an Xn connectivity may be available within the RNA; and
a RAN-based notification area update (RNAU) may be periodically sent by the UE and may be also sent when a cell reselection procedure of the UE selects a cell that does not belong to the configured RNA.

In some implementations, there are several different alternatives on how the RNA may be configured.

In one example, a list of cells may be introduced. Specifically, a UE may be provided with an explicit list of one or more cells that constitute the RNA.

In one example, a list of RAN areas may be introduced. In one aspect, a UE may be provided with (at least one) RAN area ID, where a RAN area is a subset of a CN Tracking Area or equal to a CN Tracking Area. The RAN area is specified by one RAN area ID, which may include a Tracking Area Code (TAC) and optionally a RAN area Code. In one aspect, a cell broadcasts one or more RAN area IDs in one SI.

In some implementations, the NG-RAN may provide different RNA definitions to different UEs but not mix different definitions to the same UE at the same time. The UE may support all RNA configuration options, as listed above.

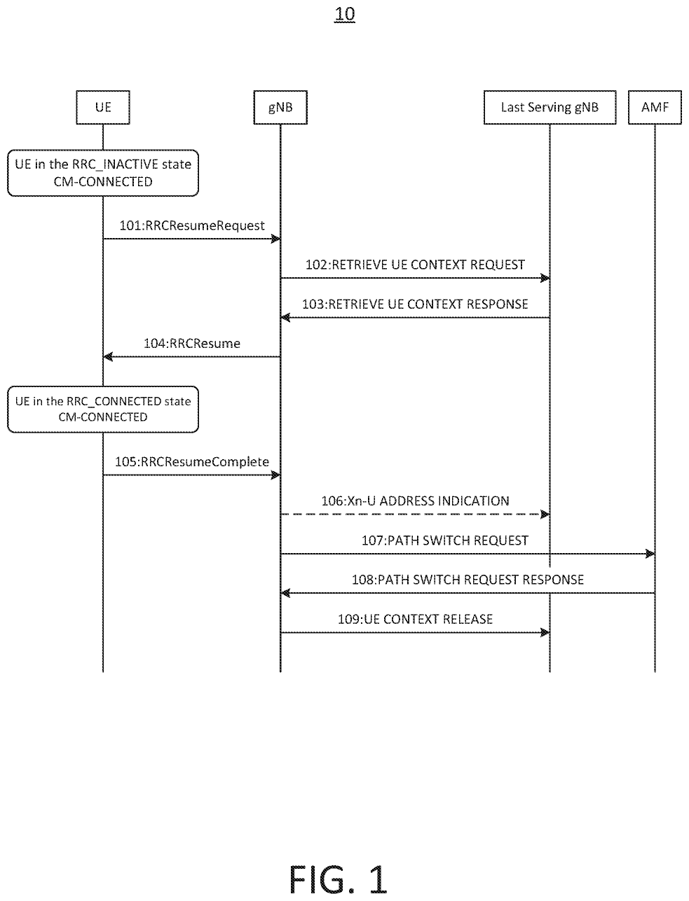

Please refer to FIG. 1, which illustrates a communication diagram 10 of a UE from an RRC_INACTIVE state to an RRC_CONNECTED state if the UE context retrieval is successful, according to an example implementation of the present disclosure.

As shown in FIG. 1, the communication diagram 10 includes the following actions. In action 101, the UE may resume from the RRC_INACTIVE state, providing the I-RNTI, allocated by the last serving gNB. In action 102, the gNB, if the gNB is able to resolve the gNB identity contained in the I-RNTI, may request the last serving gNB to provide the UE Context data. In action 103, the last serving gNB may provide the UE context data. In actions 104 and 105, the gNB and UE may complete the resumption of the RRC connection. In actions 106, if loss of DL user data buffered in the last serving gNB can be prevented, the gNB may provide forwarding addresses. In actions 107 and 108, the gNB may perform a path switch. In action 109, the gNB may trigger the release of the UE resources at the last serving gNB.

In some implementations, after the action 101, when the gNB decides to use a single RRC message to reject the Resume Request right away and keep the UE in the RRC_INACTIVE state without any reconfiguration, or when the gNB decides to setup a new RRC connection, an SRB0 (without security) is used. Alternatively, when the gNB decides to reconfigure the UE (e.g. with a new DRX cycle or an RNA) or when the gNB decides to have the UE transition to the RRC_IDLE state, an SRB1 (with integrity protection and ciphering as previously configured for that SRB) may be used.

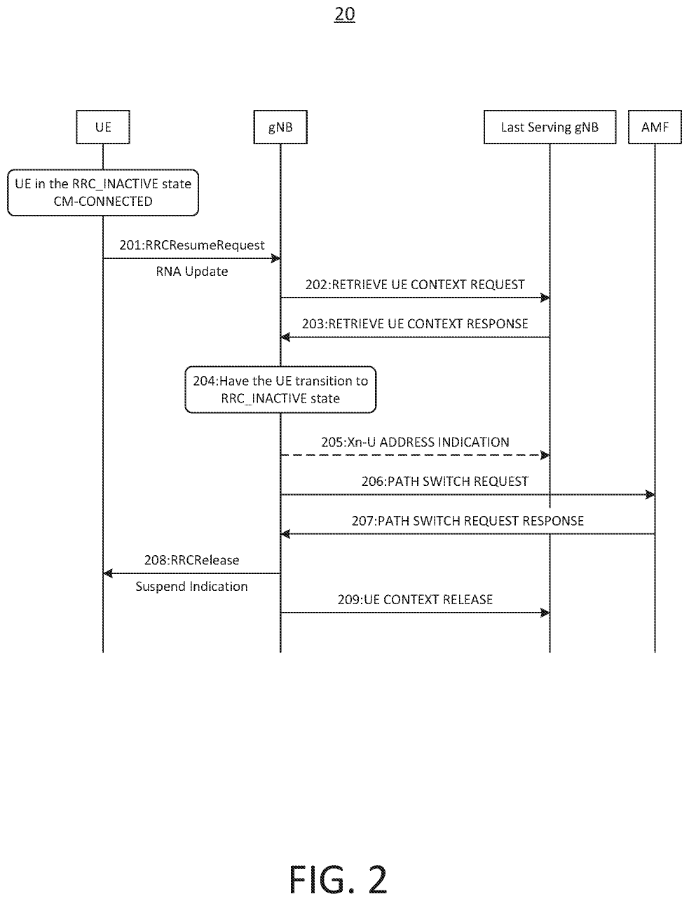

Please refer to FIG. 2, which illustrates a communication diagram 20 of a UE triggering an RNA update procedure with a UE context, according to an example implementation of the present disclosure. As shown in FIG. 2, the RNA update procedure involves the UE context retrieval over Xn, and the RNA update procedure may be triggered when the UE moves out of the configured RNA, or periodically.

As shown in FIG. 2, the communication diagram 20 includes the following actions. In actions 201, the UE may resume from the RRC_INACTIVE state, providing the I-RNTI allocated by the last serving gNB and an appropriate cause value, e.g., a RAN notification area update. In action 202, the gNB, if the gNB is able to resolve the gNB identity contained in the I-RNTI, may request the last serving gNB to provide the UE Context, providing the cause value being received in action 201. In action 203, the last serving gNB may provide the UE context. Alternatively, the last serving gNB may decide to have the UE transition to the RRC_IDLE state or, if the UE is still within the previously configured RNA, to keep the UE context in the last serving gNB and to keep the UE in the RRC_INACTIVE state. In action 204, the gNB may have the UE transition to the RRC_CONNECTED state, or may have the UE transition to the RRC_IDLE state or have the UE transition to the RRC_INACTIVE state, as assumed in the following description. In action 205, if loss of DL user data buffered in the last serving gNB can be prevented, the gNB may provide forwarding addresses. In actions 206 and 207, the gNB may perform a path switch. In action 208, the gNB may keep the UE in the RRC_INACTIVE state by sending an RRCRelease with a suspend indication. In action 209, the gNB may trigger the release of the UE resources at the last serving gNB.

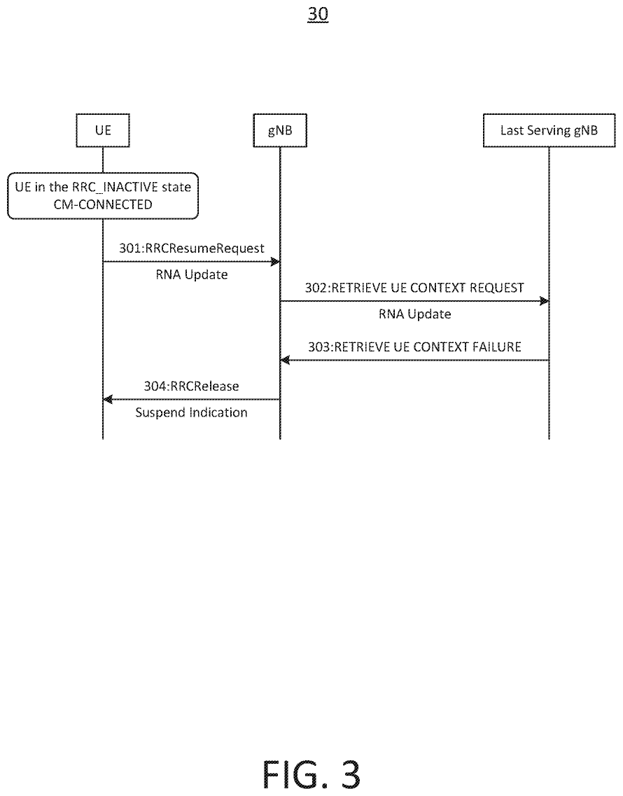

Please refer to FIG. 3, which illustrates a communication diagram 30 of a periodic RNA update procedure without a UE context, according to an example implementation of the present disclosure. As shown in FIG. 3, the RNA update procedure may be performed when the UE is still within the configured RNA and the last serving gNB decides not to relocate the UE context and to keep the UE in the RRC_INACTIVE state.

As shown in FIG. 3, the communication diagram 30 includes the following actions. In action 301, the UE may resume from the RRC_INACTIVE state, providing the I-RNTI allocated by the last serving gNB and an appropriate cause value, e.g., a RAN notification area update. In action 302, the gNB, if the gNB is able to resolve the gNB identity contained in the I-RNTI, may request the last serving gNB to provide the UE Context, providing the cause value being received in action 301. In action 303, the last serving gNB may store the received information to be used in the next resume attempt (e.g. a C-RNTI and a PCI related to the resumption cell), and may respond to the gNB with the RETRIEVE UE CONTEXT FAILURE message including an encapsulated RRCRelease message. The RRCRelease message may include a Suspend Indication. In action 304, the gNB may forward the RRCRelease message to the UE.

SDT

In some implementations, the NR system may support the UEs in the RRC_INACTIVE state with infrequent (periodic and/or non-periodic) data transmissions that are generally maintained by the NW in the RRC_INACTIVE state. Until Rel-16, the RRC_INACTIVE state doesn't support data transmission. Hence, the UE has to resume the connection (e.g., moving to the RRC_CONNECTED state from the RRC_INACTIVE state) for any DL (MT) and UL (MO) data. A connection setup and subsequently release to the RRC_INACTIVE state may happen for each data transmission with the small and infrequent data packets, such that unnecessary power consumption and signaling overhead may occur.

In some implementations, signaling overhead from the RRC_INACTIVE state of UEs for the small data packets may be a general problem, and may become a critical issue with more UEs in NR not only for the NW's performance and efficiency but also for UE battery performance. In general, any device that has intermittent small data packets in the RRC_INACTIVE state may benefit from enabling SDT in the RRC_INACTIVE state.

In some implementations, the key enablers for the SDT in the NR, namely the RRC_INACTIVE state, a 2-step RACH, a 4-step RACH, and a CG type 1 may have been specified as part of 3GPP Rel-15 and Rel-16. Thus, this work may build on these fundamental techniques to enable the SDT in the RRC_INACTIVE state for the NR.

In some implementations, an SDT procedure may be introduced with the following implementations, as specified in Rel-17.

In one example, for the RRC_INACTIVE state, the UL SDT for RACH-based schemes (e.g., the 2-step RACH and/or the 4-step RACH) may include the following: General procedure to enable UP data transmission for small data packets from the RRC_INACTIVE state (e.g. using a MSGA or a MSG3);

Enabling flexible payload sizes to be larger than the Rel-16 CCCH message size that is currently used for the RRC_INACTIVE state via the MSGA and/or the MSG3 to support UP data transmission in UL (the actual payload size may be up to NW configuration); and
Context fetching and data forwarding (with and without an anchor relocation) in the RRC_INACTIVE state for RACH-based solutions.

In one example, transmission of UL data on pre-configured PUSCH resources (e.g., reusing the CG type 1) may include at least one of the following (when a TA is valid): General procedure for the SDT over CG type 1 resources from the RRC_INACTIVE state; and Configuration of the CG type 1 resources for the SDT in UL for RRC_INACTIVE state.

In one example, it may specify RRM core requirements for the SDT in the RRC_INACTIVE state, if needed.

In some implementations, it should be noted that no new RRC state may be introduced in Rel-17 for enabling the SDT, and the transmission of small data in UL, subsequent transmission of small data in UL and DL, and the state transition decisions may be under NW control.

In some implementations, upon entering into the RRC_INACTIVE state, the UE may be configured with the SDT configurations that may indicate which SRB(s)/DRB(s) are eligible to use the SDT procedure and therefore are able to be transmitted in the RRC_INACTIVE state. The DRB that is eligible to use the SDT procedure is named as “SDT DRB” and the DRBs that are not eligible are named as “non-SDT DRBs” in the following description. The SDT configurations may further include the parameters and/or criteria for the UE to determine the transmission scheme (e.g., the 2-step RACH, the 4-step RACH, or the CG type 1) to be used in transmitting small data in the RRC_INACTIVE state. Specifically, based on the configured parameters and/or criteria, the measured signal strength/quality (e.g., RSRP/RSRQ) of the serving cell, and/or the amount of data to be transmitted, the UE may be able to determine whether or not to use the SDT procedure to transmit the data in the RRC_INACTIVE state, and also determine which transmission scheme to use if the data is to be transmitted in the RRC_INACTIVE state.

RACH-Based SDT Procedure

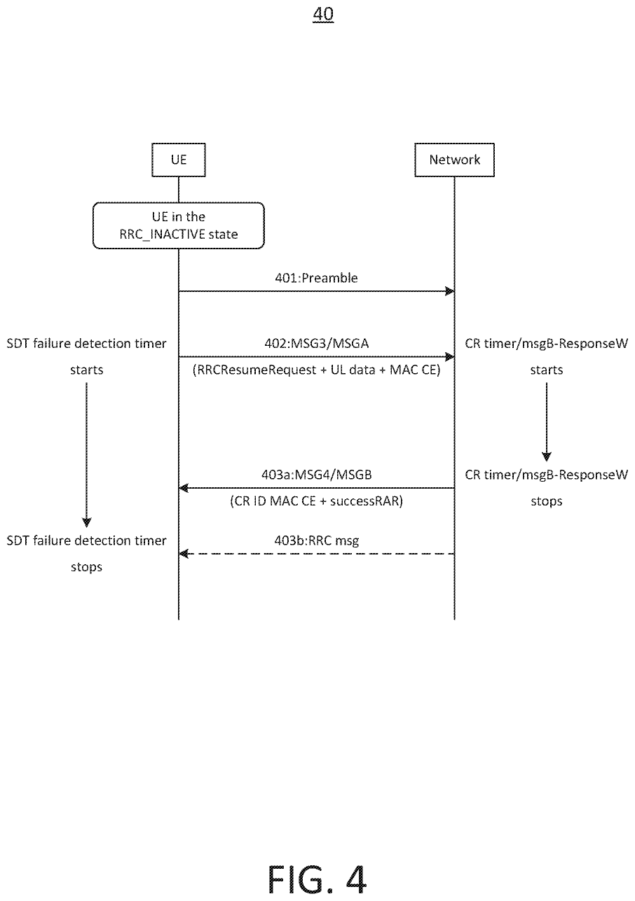

In some implementations, in a case that the UE user data arrives for the SDT DRBs, and the UE selects the 4-step RACH or the 2-step RACH procedure as the transmission scheme to perform the SDT, the procedure may be as illustrated in FIG. 4, which illustrates a communication diagram 40 of a RACH-based SDT procedure, according to an example implementation of the present disclosure. As shown in FIG. 4, the communication diagram 40 includes the following steps.

In action 401, the UE may transmit a preamble within a RO and may start the SDT failure detection timer, where the preamble and/or RO may be configured exclusively for the SDT purpose. In the case of the 4-step RACH, once the preamble is transmitted, the UE may receive a RAR indicating a UL grant for a MSG3 transmission; in the case of the 2-step RACH, once the preamble is transmitted, the UE may find a PUSCH resource that is associated with the transmitted preamble, for the transmission of the MSGA payload.

In action 402, the UE may transmit to the NW an RRC Resume Request message and may transmit together therewith the user data from the SDT DRB, using the UL grant for the MSG3 transmission (in the case of the 4-step RACH) or using the associated PUSCH resource for the MSGA transmission (in the case of the 2-step RACH). The RRC Resume Request message may further indicate the purpose of sending the message (e.g., indicating that the UE is sending a small data in the RRC_INACTIVE state). In addition to the RRC Resume Request message and the user data, the UE may further include a MAC CE (e.g., a BSR MAC CE) in the MSG3/MSGA transmission. Upon transmitting the RRC Resume Request message, the UE may start a ra-ContentionResolutionTimer (in the case of the 4-step RACH) or a msgB-ResponseWindow (in the case of the 2-step RACH), and may also start the SDT failure detection timer.

In actions 403a and 403b, once the MSG3/MSGA has been transmitted, the UE may monitor the PDCCH addressed to at least the TEMPORARY_C-RNTI (in the case of the 4-step RACH) or the MSGB-RNTI (in the case of the 2-step RACH) while the ra-ContentionResolutionTimer (in the case of the 4-step RACH) or the msgB-ResponseWindow (in the case of the 2-step RACH) is still running. Upon monitoring the PDCCH addressed to the above-mentioned RNTIs, as long as the UE receives the UE Contention Resolution Identity MAC CE (e.g., a Contention Resolution Identity MAC CE) or the successRAR, where the UE Contention Resolution Identity may match the CCCH SDU transmitted in action 402, the UE may consider the contention resolution is successful and may end the RACH procedure (and also the corresponding timer ra-ContentionResolutionTimer/msgB-ResponseWindow). If the RRC message (e.g., an RRCRelease, or an RRCResume message) corresponding to the RRC resume request message is multiplexed together with the above-mentioned UE Contention Resolution Identity MAC CE or the successRAR message, the UE may also consider the SDT procedure is completed and stop the SDT failure detection timer. If the RRC message corresponding to the RRC resume request message is not multiplexed together with the above-mentioned UE Contention Resolution Identity MAC CE or the successRAR message, the UE may continue monitoring the PDCCH addressed to its C-RNTI when the SDT failure detection timer is still running, until the RRC message corresponding to the RRC Resume Request message is received or until the SDT failure detection timer expires. If the above-mentioned RRC message is received and if the received RRC message is an RRCRelease message with a suspendConfig IE, the UE may still remain in the RRC_INACTIVE state. If the above-mentioned RRC message is received and if the received RRC message is an RRCRelease message without the suspendConfig IE, the UE may transition to the RRC_IDLE state. If the above-mentioned RRC message is received and if the received RRC message is an RRCResume message, the UE may transition to the RRC_CONNECTED state.

CG-Based SDT Procedure

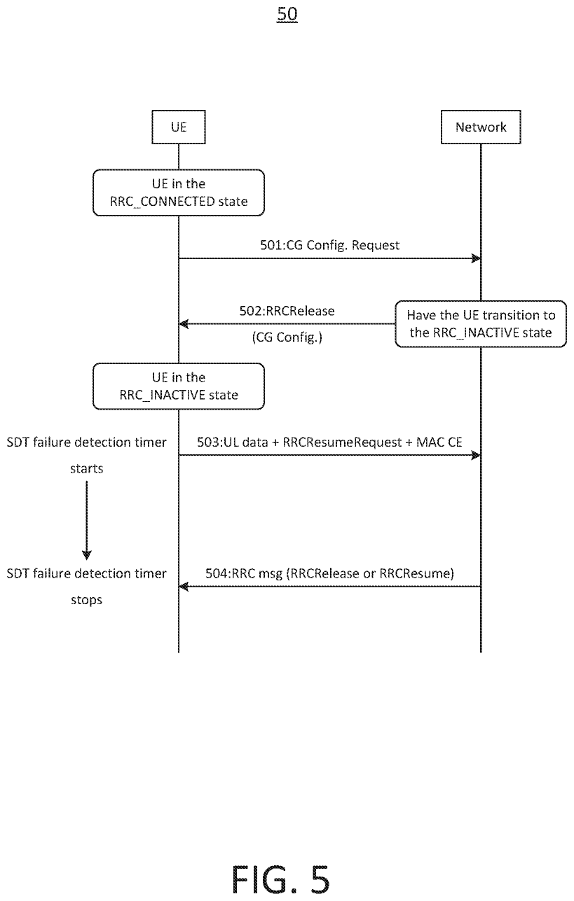

Please refer to FIG. 5, which illustrates a communication diagram 50 of a CG-based SDT procedure, according to an example implementation of the present disclosure. As shown in FIG. 5, the communication diagram 50 includes the following steps.

In action 501, when the UE is in the RRC_CONNECTED state and/or the RRC_INACTIVE state, the UE may send a CG configuration request to the NW to indicate its preference for CG configuration to be used in the SDT and/or in the RRC_INACTIVE state.

In action 502, the NW may decide to have the transition UE to the RRC_INACTIVE state by sending the RRCRelease message (including a suspendconfig IE) to the UE. The RRCRelease message may include at least a CG configuration to configure the CG resources for the UE. The CG configuration may include, but is not limited to, the following parameters/fields: a CG periodicity, a TBS, a number for the implicit release of the CG resources, a CG Timer, a retransmission timer, a number of HARQ process reserved for the CG in the SDT, an RSRP threshold for an SSB selection and association between an SSB and CG resources, TA-related parameters (e.g., a cg-SDT-TimeAlignmentTimer), and so on.

In action 503, in a case that the UE user data arrives for the SDT SRBs/DRBs and the UE selects the CG procedure as the transmission scheme to perform the SDT, the UE may send the user data in the nearest CG resource configured in action 502. The UE may also multiplex the user data with the RRC Resume Request message and/or a MAC CE and may also start the SDT failure detection timer upon sending the RRC Resume Request message.

Upon sending the user data in action 503, the UE may monitor a PDCCH via a specific RNTI (e.g., a C-RNTI, a CS-RNTI, and/or an SDT RNTI) on an SS (e.g., configured by the CG configuration) to receive the dynamic scheduling for UL and/or DL new transmission (including an RRC message) and/or the corresponding retransmission. The UE may monitor the PDCCH via the specific RNTI to receive the dynamic scheduling for the retransmission of the CG.

In action 504, the NW may send an RRC release (with a suspendConfig or without the suspendConfig) message to keep the UE in the RRC_INACTIVE state or have the UE transition to the RRC_IDLE state. Alternatively, the NW may send an RRC resume message to have the UE transition to the RRC_CONNECTED state. Once the RRCRelease message (with the suspendConfig IE) is received, the UE may terminate the SDT procedure based on the RRCRelease message, and/or stop monitoring the specific RNTI, and/or stay in the RRC_INACTIVE state.

Subsequent Data Transmissions in the SDT Procedure

The above-mentioned SDT procedure (including both the RACH-based SDT procedure and the CG-based SDT procedure) may allow the UE to at least transmit the user data in “one shot” and then keep the UE in the RRC_INACTIVE state after the one-shot transmission. In some implementations, in a case that the UE cannot transmit all the SDT data via the one-shot transmission, the UE may include the buffer status report while transmitting the small data. The NW may instruct the UE to transition to the RRC_CONNECTED state after receiving the buffer status report, so as to allow UE to transmit the remaining data in the RRC_CONNECTED state. As mentioned earlier, having the UE transition to the RRC_CONNECTED state may result in a lot of control overhead and significantly consume UE's power, which is not efficient if the UE only has few portions of data remaining in the buffer. As such, 3GPP standards have agreed to make it possible for the UE or the NW to execute multiple data transmissions (DL/UL) in one SDT procedure. Specifically, once the UE has sent the RRC Resume Request together with one user data, the UE may receive “subsequent” UL grants/DL transmissions from the NW before the UE receives the RRC message that terminates the SDT procedure (e.g., before the UE receives an RRCRelease message or an RRCResume message). To make subsequent data transmissions happen, the UE may need to keep monitoring the USS and RNTI (e.g., C-RNTI, a TEMPORARY_C-RNTI, a CS-RNTI, and/or an SDT-RNTI) while the SDT failure detection timer is still running, even if the RA procedure used to trigger the SDT has ended (in the case of the RACH-Based SDT). In one alternative, the SDT failure detection timer may be long enough to cover multiple UL/DL transmissions between the UE and the NW; in another alternative, the SDT failure detection timer may use a timer T319 as the basis (e.g., the same timer starting/stopping conditions) and further extend T319 to become the SDT failure detection timer (e.g., T319a). Alternatively, besides the starting/stopping conditions, the failure detection timer may employ a new timer restarting condition, which may restart the timer upon each UL/DL data transmission performed between the UE and the NW. By introducing the timer restarting condition, it may avoid extending the timer length and avoid impacting the UE who triggers an SDT procedure for carrying out the one-shot transmission.

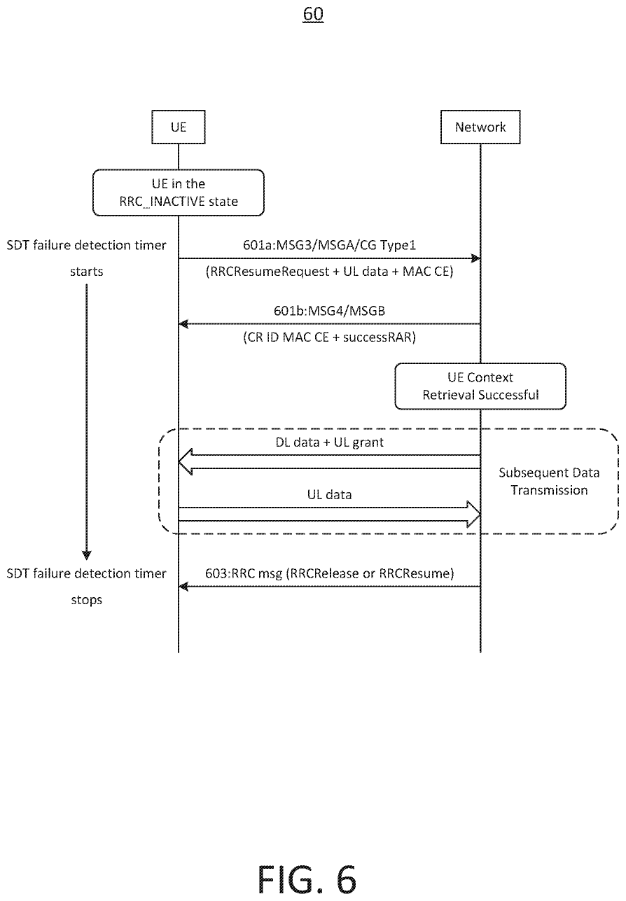

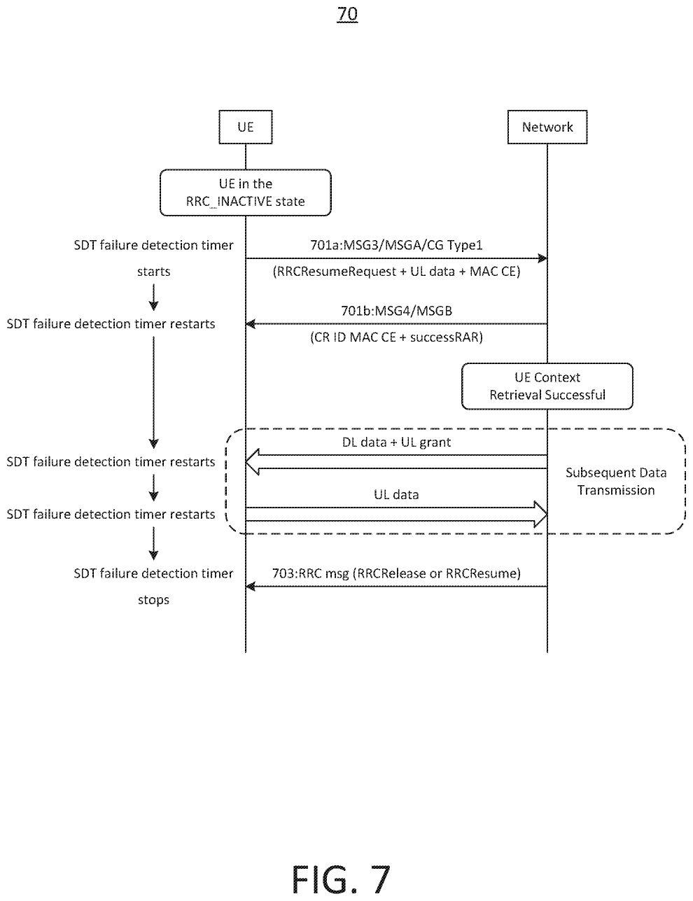

In some implementations, from the UE's perspective, to enable subsequent data transmissions in an SDT procedure, the UE may need to inform the NW that the UE has remaining SDT data to be sent even after the current UL transmission, which may be done by piggybacking a BSR MAC CE in a UL transmission. From the NW's perspective, to enable subsequent data transmissions in an SDT procedure, the NW may need to delay the transmission of the RRC message that ends the SDT procedure until all the remaining SDT data have been cleared. Accordingly, in the case of the RACH-Based SDT, the NW may need to end the RACH procedure first by sending the Contention Resolution Identity MAC CE or the successRAR alone as the MSG4/MSGB, and then sending the RRC message later before the SDT failure detection timer expires. More details are introduced in FIG. 6 and FIG. 7, where FIG. 6 illustrates a communication diagram 60 of an SDT procedure with subsequent data transmissions without timer restarting condition(s), and FIG. 7 illustrates a communication diagram 70 of an SDT procedure with subsequent data transmission timer restarting condition(s), according to example implementations of the present disclosure.

In some implementations, while monitoring for the subsequent data transmission, the UE may need to monitor the PDCCH, e.g., to receive the possible (DL and/or UL) scheduling from the NW. The UE may monitor the PDCCH based on an SS, a CORESET, and/or an RNTI. For example, the UE may monitor the PDCCH addressed to the C-RNTI after a successful completion of the RA procedure for the SDT.

In one example, the SS may include at least one of the following:

### Option 1: CSS

E.g., CSS(s) configured in a PDCCH-ConfigCommon

E.g., the type-1 PDCCH CSS set configured by a ra-SearchSpace

E.g., the type-3 PDCCH CSS set

E.g., SS zero

E.g., a new CSS set configured via an SI (e.g., a SIB) or an RRC release message

E.g., SS with parameters of the SS(s) configured in the initial BWP

### Option 2: USS

E.g., a USS set configured via an RRC Release message

E.g., a USS set configured via the MSG4/MSGB

E.g., a USS set configured via a PDCCH-Config

E.g., a USS set configured via configuration(s) for the SDT

E.g., an SS with ID other than 0-39

E.g., an SS set identified as a specific set for the SDT

In one example, the CORESET may include at least one of the following:

Option 1: common CORESET

E.g., CORESET 0

E.g., CORESET other than CORESET 0

Option 2: UE-specific CORESET configuration

E.g., a UE-specific CORESET configured via an RRC Release message

E.g., a UE-specific CORESET configured via the MSG4/MSGB

E.g., a UE-specific CORESET configured via configuration(s) for the SDT

E.g., a CORESET with ID other than 0-14

In some implementations, the RNTI may include at least one of the following: a C-RNTI, a CS-RNTI, an RNTI for the SDT, an RNTI for the CG, and/or a new RNTI other than SI-RNTI, an RA-RNTI, a MsgB-RNTI, a Temporary Cell (TC)-RNTI, a Paging (P)-RNTI, an Interruption (INT)-RNTI, a Slot Format Indicator (SFI)-RNTI, a Transmission Power Control (TPC)-PUSCH-RNTI, a TPC-PUCCH-RNTI, a TPC-SRS-RNTI, a Cancellation Identification (CI)-RNTI, a Modulation and Coding Scheme (MCS)-C-RNTI, a Power Saving (PS)-RNTI, an SL-RNTI, an SL-CS-RNTI, and an SL Semi-Persistent Scheduling (SPS) V-RNTI.

Issues to be Addressed

In some implementations, upon the data arrival from non-SDT SRB/DRBs, the UE in the RRC_INACTIVE state may need to perform the legacy RRC resume procedure with the intention to transition to the RRC_CONNECTED state by sending an RRC resume request message to the NW. In a case that the data of the non-SDT SRB/DRB arrives during an ongoing SDT procedure, the UE may send the RRC resume request again (e.g., on a CCCH) or a DCCH message to the NW given that the UE has already sent the RRC resume request once to the NW to trigger the SDT procedure. After sending either the RRC resume request or the DCCH message to the NW during an ongoing SDT procedure, since the UE may either receive one or two RRC messages as the response (for the RRC resume request or the DCCH message) from the NW, it is unclear whether the UE shall stop the SDT failure detection timer and/or terminate the SDT procedure upon receiving the first RRC message (as the response to the RRC resume request) sent by the NW. Noticeably, the SDT failure detection timer may be started when sending the RRC resume request to trigger the SDT procedure. The UE may keep performing the SDT procedure while the SDT failure detection timer is running. Stopping the SDT failure detection timer and/or terminate the SDT procedure may also stop the UE from further receiving the second RRC message that may be sent by the NW as the response to the second RRC message (e.g., the second RRC resume request or the DCCH message) that the UE has sent.

In some implementations, in a case that the UE intends to send a DCCH message (e.g., instead of the RRC resume request) to the NW upon detecting the arrival of non-SDT SRB/DRBs while there is no UL resource/grant available for the UE, it is unclear whether the UE is allowed to trigger an RA procedure for sending DCCH messages in the RRC_INACTIVE state. If UE is allowed to trigger an RA procedure for sending DCCH messages in the RRC_INACTIVE state, it is also unclear which UE identity shall be provided to the NW together with the DCCH message and whether it is required to multiplex an additional RRC message or MAC CE(s) with the DCCH message in the MSG3/MSGA in order to carry the UE identity.

In some implementations, upon the NW receiving an indication from the UE that informs the NW of the arrival of non-SDT traffic, it is unclear how the NW should respond if the indication is delivered via the DCCH approach. The NW may terminate the ongoing SDT procedure and have the UE transition to either the RRC_CONNECTED state or keep the UE in the RRC_INACTIVE state with updated SDT configurations. In a case that the NW decides to keep the UE in the RRC_INACTIVE state and provide the UE with the updated SDT configurations (e.g., the updated SDT configurations may turn the non-SDT SRB/DRBs into SDT SRB/DRBs), it is expected that the UE may initiate a new SDT procedure for sending the accumulated data (e.g., including the suspended SDT data due to the termination of the ongoing SDT procedure and the new arrival of the non-SDT data) in the UE buffer. Therefore, a more efficient and collision-free method allowing the UE to transmit these accumulated data is beneficial from both the UE's and NW's perspectives.

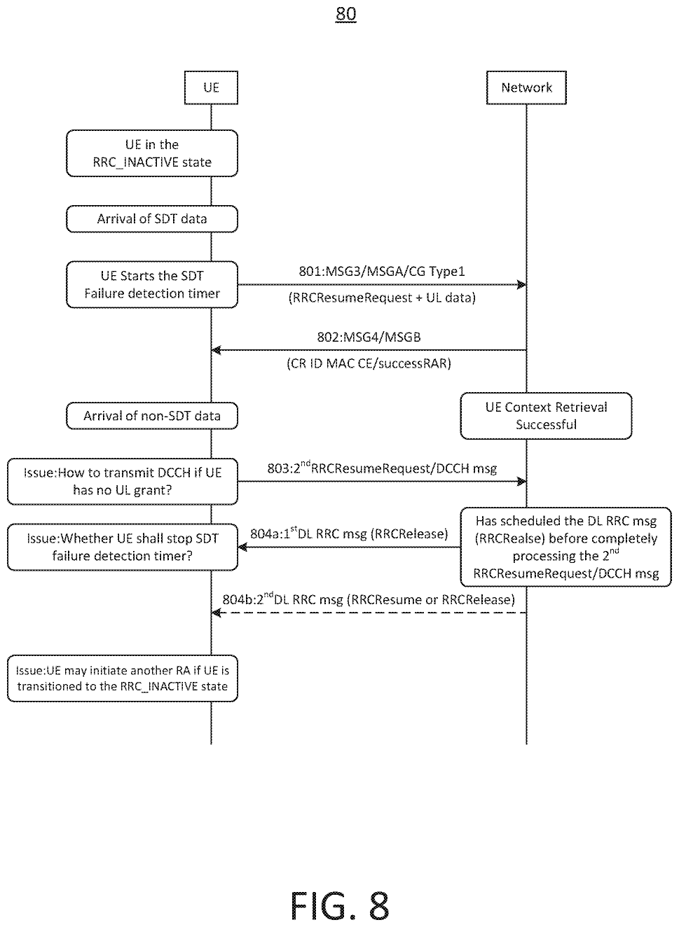

More details are introduced in FIG. 8, which illustrates a communication diagram 80 of an exemplary procedure specifying the issues for the UE/NW upon the UE detecting the arrival of non-SDT data, according to an example implementation of the present disclosure.

Proposed Solutions

UE Behavior Upon Detecting the Arrival of Non-SDT Traffic

In some implementations, the UE may receive, from the NW, an RRCRelease message with a suspendConfig IE that includes the SDT configuration and has the UE enter into the RRC_INACTIVE state.

In some implementations, the UE may detect the data arrival from the SDT DRB/SRB and the data volume (e.g., calculated as the total sum of Buffer Size across SDT RBs) is smaller than a data volume threshold broadcast/configured (e.g., broadcast in a common SDT configuration by an SI and/or configured in an SDT configuration by an RRC release message) by the NW. In addition, the measured signal strength/quality (e.g., an RSRP) of the camped cell is greater than a signal strength/quality threshold (e.g., an RSRP threshold) broadcast/configured (e.g., broadcast in a common SDT configuration by an SI and/or configured in an SDT configuration by an RRC release message) by the NW.

In some implementations, the UE may determine to trigger the SDT procedure and send an RRC resume request message (e.g., mandatory) together with the pending SDT data (e.g., optional) and/or a BSR MAC CE (e.g., optional) to the NW.

In one example, the UE may send the RRC resume request message together with the pending SDT data and/or the BSR MAC CE in a CG resource, if the UE is configured with CG resources for the SDT and the CG resources associated with a beam that the UE selects are still valid (e.g., a signal strength/quality/RSRP of the beam is qualified and a UE's TA timer for CG has not expired).

In one example, when the UE is not able to use the CG resource for the SDT transmission, the UE may send the RRC resume request message together with the pending SDT data and/or the BSR MAC CE in a MSGA PUSCH resource, if a) the camped cell is configured with both the 2-step RACH resources and the 4-step RACH resources for the SDT and if the measured signal strength/quality/RSRP of the camped cell is greater than another signal strength/quality/RSRP threshold (e.g., a msgA-RSRP-Threshold) broadcast by the NW, or b) the camped cell is only configured with the 2-step RACH resource for the SDT.

In one example, when the UE is not able to use the CG resource nor the MSGA PUSCH resource for the SDT transmission, the UE may send the RRC resume request message together with the pending SDT data and/or the BSR MAC CE in a MSG3 grant, if the camped cell is configured with the 4-step RACH resource for the SDT.

In one example, if the UE is not able to perform the SDT via the CG resource, the MSGA PUSCH resource, or the MSG3 grant, the UE may fallback to perform the legacy RRC resume procedure by sending the RRC resume request message to the NW.

In some implementations, after determining to trigger the SDT procedure/sending an RRC resume request message and before receiving the RRC message (e.g., as a response to the RRC resume request message) from the NW that terminates the SDT procedure (e.g., an RRCResume message or an RRCRelease message), the UE may further detect whether data arrival from the non-SDT DRB/SRB occurs.

In one example, in a case that the UE selects the 4-step RACH as the mechanism to perform the SDT and detects the data arrival from the non-SDT DRB/SRB after the UE has transmitted the PRACH resource for triggering the SDT procedure and before the UE has transmitted the first UL message of the SDT procedure in the MSG3 grant scheduled by the NW, the UE may perform at least one of the following actions.

In one action, the UE may cancel/stop/terminate the current 4-step RACH procedure for the SDT, ignore the MSG3 grant scheduled by the NW (and/or consider the current 4-step RACH procedure unsuccessfully completed), and trigger another 4-step RACH procedure or another 2-step RACH procedure for performing the legacy RRC resume procedure that uses the PRACH resources configured for the normal/legacy RA procedure.

In one action, the UE may transmit the RRC resume request message with padding bits (without multiplexing the SDT data and/or the BSR MAC CE) as the first UL message of the SDT procedure in the MSG3 grant scheduled by the NW. The padding bits are used by the UE to implicitly inform the NW of the data arrival from the non-SDT SRB/DRB. The RRC resume request message may explicitly/implicitly indicate that the UE is performing the legacy RRC resume procedure, via using the existing resume causes specified in the Rel-16 specification, or via not including a new IE whose presence implies the UE is performing an SDT procedure.

In one action, the UE may transmit the RRC resume request message together with a new UL DCCH message that is used to inform/report the data arrival from the non-SDT DRB/SRB during the SDT procedure as the first UL message of the SDT procedure in the MSG3 grant scheduled by the NW.

In one aspect, the new UL DCCH message is a new UL DCCH message type created in addition to the existing message types (e.g., a MeasurementReport, an RRCReconfigurationComplete, an RRCSetupComplete, an RRCReestablishmentComplete, an RRCResumeComplete, a SecurityModeComplete, a SecurityModeFailure, a ULInformationTransfer, a LocationMeasurementIndication, a UECapabilityInformation, a CounterCheckResponse, a UEAssistanceInformation, a FailureInformation, a ULInformationTransferMRDC, an SCGFailureInformation, an SCGFailureInformationEUTRA, a ULDedicatedMessageSegment-r16, a DedicatedSIBRequest-r16, an MCGFailureInformation-r16, a UEInformationResponse-r16, a SidelinkUEInformationNR-r16, a ULInformationTransferIRAT-r16, or an IABOtherInformation-r16) listed in the UL-DCCH-MessageType.

In one aspect, the new UL DCCH message is ciphered and integrity-protected, and may further indicate which non-SDT DRB(s)/SRB(s) has the data pending at the UE side, and may also indicate the amount of data (e.g., a coarse amount or a fine amount) pending for transmission for each non-SDT DRB/SRB.

More details are shown in below in Table 1.

TABLE 1

| | |
|---|---|
| UL-DCCH-Message ::= | SEQUENCE { |
| message | UL-DCCH-MessageType |
| } | |
| UL-DCCH-MessageType ::= | CHOICE { |
| c1 | CHOICE { |
| measurementReport | , |
| rrcReconfigurationComplete | RRCReconfigurationComplete, |
| rrcSetupComplete | RRCSetupComplete, |
| rrcReestablishmentComplete | RRCReestablishmentComplete, |
| rrcResumeComplete | RRCResumeComplete, |
| securityModeComplete | SecurityModeComplete, |
| securityModeFailure | SecurityModeFailure, |
| ulInformationTransfer | ULInformationTransfer, |
| locationMeasurementIndication | LocationMeasurementIndication, |
| ueCapabilityInformation | UECapabilityInformation, |
| counterCheckResponse | CounterCheckResponse, |
| ueAssistanceInformation | UEAssistanceInformation, |
| failureInformation | FailureInformation, |
| ulInformationTransferMRDC | ULInformationTransferMRDC, |
| scgFailureInformation | SCGFailureInformation, |
| scgFailureInformationEUTRA | SCGFailureInformationEUTRA |
| }, | |
| messageClassExtension | CHOICE { |
| c2 | CHOICE { |
| ulDedicatedMessageSegment-r16 | ULDedicatedMessageSegment-r16, |
| dedicatedSIBRequest-r16 | DedicatedSIBRequest-r16, |
| mcgFailureInformation-r16 | MCGFailureInformation-r16, |
| ueInformationResponse-r16 | UEInformationResponse-r16, |
| sidelinkUEInformationNR-r16 | SidelinkUEInformationNR-r16, |
| ulInformationTransferIRAT-r16 | ULInformationTransferIRAT-r16, |
| iabOtherInformation-r16 | IABOtherInformation-r16, |
| nonSDTDataArrival-r17 | NonSDTDataArrival-r17, |

```
    spare8 NULL, spare7 NULL, spare6 NULL,
    spare5 NULL, spare4 NULL, spare3 NULL, spare2 NULL, spare1 NULL
```

| | |
|---|---|
| }, | |
| messageClassExtensionFuture-r16 | SEQUENCE { } |
| } | |
| } | |
| NonSDTDataArrival-r17 ::= | SEQUENCE { |
| criticalExtensions | CHOICE { |
| nonSDTDataArrival-r17 | NonSDTDataArrival-r17-Ies, |
| criticalExtensionsFuture | SEQUENCE{ } |
| } | |
| } | |
| NonSDTDataArrival-r17-Ies ::= | SEQUENCE { |
| nonSDT-DRB-List-r17 | SEQUENCE (SIZE (1.. maxDRB)) OF DRB-List-r17, |
| nonSDT-SRB-List-r17 | SEQUENCE (SIZE (1.. 2)) OF SRB-List-r17 |
| } | |

```
DRB-List-r17 ::= SEQUENCE {
  drb-Identity DRB-Identity,
  dataAmount CHOICE {
  coarseAmount ENUMERATED {small, medium, large},
  fineAmount INTEGER (0..31)
  }
}
SRB-List-r17 ::= SEQUENCE {
  srb-Identity SRB-Identity,
  dataAmount CHOICE {
  coarseAmount ENUMERATED {small, medium, large},
  fineAmount INTEGER (0..31)
  }
}
```

In one aspect, the priority of the UL DCCH message to be multiplexed may be lower than data from UL-CCCH (e.g., RRC resume request message) and higher than other data and/or MAC CE(s). More details are introduced below.

In an LCP procedure, logical channels may be prioritized in accordance with the following order (highest priority listed first):

C-RNTI MAC CE or data from UL-CCCH;

### UL-DCCH (e.g., for SDT);

### CG Confirmation MAC CE or BFR MAC CE or Multiple Entry CG Confirmation MAC CE;

### SL CG Confirmation MAC CE;

LBT failure MAC CE;
MAC CE for SL-BSR prioritized;
MAC CE for BSR, with exception of BSR included for padding;

### Single-Entry PHR MAC CE or Multiple-Entry PHR MAC CE;

MAC CE for the number of Desired Guard Symbols;

### MAC CE for Pre-emptive BSR;

MAC CE for SL-BSR, with exception of SL-BSR prioritized and SL-BSR included for padding;
data from any logical channel, except data from UL-CCCH;
MAC CE for Recommended bit rate query;
MAC CE for BSR included for padding; and
MAC CE for SL-BSR included for padding.

In one action, the UE may transmit the RRC resume request message as the first UL message via the MSG3 of an RA procedure of the SDT procedure. The UE may receive the MSG4 to complete the RA procedure of the SDT procedure and keep performing the SDT procedure. The UE may transmit the UL DCCH message (that is used to inform/report the data arrival from the non-SDT DRB/SRB) via a UL resource dynamically scheduled by the NW during the ongoing SDT procedure after the RA procedure is completed. Alternatively, the UL resource may be scheduled by the MSG4.

In one example, in a case that the UE selects the 4-step RACH as the mechanism to perform the SDT and detects the data arrival from the non-SDT DRB/SRB after the UE has transmitted the first UL message of the SDT procedure in the MSG3 grant scheduled by the NW, the UE may perform at least one of the following actions.

In one action, the UE may cancel/stop/terminate the current SDT procedure, stop monitoring the PDCCH addressed to the UE (via a C-RNTI, a TEMPORARY_C-RNTI, a CS-RNTI, and/or a UE-specific SDT-RNTI) (and/or consider the current 4-step RACH procedure unsuccessfully completed), and trigger another 4-step RACH procedure or another 2-step RACH procedure for performing the legacy RRC resume procedure that uses the PRACH resource configured for the normal/legacy RA procedure.

In one aspect, the UE may cancel/stop/terminate the current SDT procedure, stop monitoring the PDCCH addressed to the UE (via a C-RNTI, a TEMPORARY_C-RNTI, a CS-RNTI, and/or a UE-specific SDT-RNTI) (and/or consider the current 4-step RACH procedure unsuccessfully completed), and trigger another 4-step RACH procedure or another 2-step RACH procedure by transmitting the PRACH resource configured for the normal/legacy RA procedure, in order to obtain a UL grant/resource for transmitting the new UL DCCH message that is used to inform/report the data arrival from the non-SDT DRB/SRB during an SDT procedure. In a case that the contention resolution has been resolved (e.g., the UE has received the contention resolution identity in the MAC CE and/or if the UE Contention Resolution Identity in the MAC CE matches the CCCH SDU transmitted in the Msg3) before the UE cancels/stops/terminates the current SDT procedure, the UE may transmit the new UL DCCH message together with the C-RNTI MAC CE carrying the UE's C-RNTI in the UL grant/resource obtained after triggering another 4-step RACH procedure or another 2-step RACH procedure.

In one aspect, in a case that the contention resolution has been considered successful (e.g., the UE has received the contention resolution identity in the MAC CE and/or if the UE Contention Resolution Identity in the MAC CE matches the CCCH SDU transmitted in the Msg3) and/or the RA procedure has been considered successfully completed, the UE may transmit the new UL DCCH message together with the C-RNTI MAC CE carrying the UE's C-RNTI and/or a new MAC CE carrying the UE's full I-RNTI or short I-RNTI in the UL grant/resource obtained after triggering another 4-step RACH procedure or another 2-step RACH procedure.

In one aspect, regardless of whether the contention resolution has been resolved or not (e.g., regardless of whether the UE has received the contention resolution identity in the MAC CE or not and/or regardless of whether the UE has received the MSG4), upon canceling/stopping/terminating the current SDT procedure, the UE may transmit the new UL DCCH message together with a new MAC CE carrying the UE's full I-RNTI or short I-RNTI and/or together with C-RNTI MAC CE carrying the UE's C-RNTI in the UL grant/resource obtained after triggering another 4-step RACH procedure or another 2-step RACH procedure.

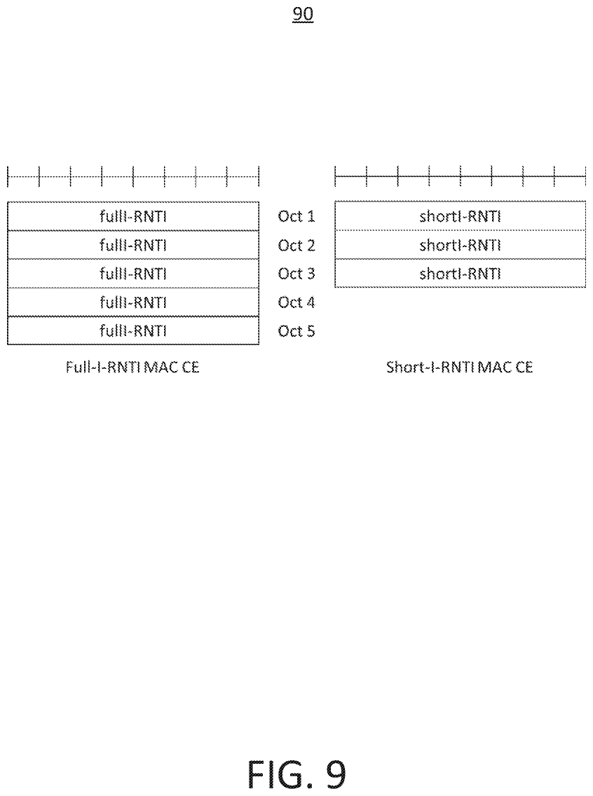

In one aspect, the new UL DCCH message may include the C-RNTI, the full I-RNTI, and/or the short I-RNTI. Please refer to FIG. 9, which illustrates a diagram 90 of a full-I-RNTI MAC CE and a short-I-RNTI MAC CE, according to an example implementation of the present disclosure.

In one action, the UE may wait for the next UL transmission opportunity (for the subsequent data transmission) by monitoring the PDCCH addressed to the UE (via a C-RNTI, a TEMPORARY_C-RNTI, a CS-RNTI, and/or a UE-specific SDT-RNTI) until receiving the RRC message (e.g., an RRC Release message) that terminates the SDT procedure. If there is a UL grant scheduled to the UE before the UE receives the RRC message to terminate the SDT procedure, the UE may transmit the new UL DCCH message that is used to inform/report the data arrival from the non-SDT DRB/SRB during the SDT procedure in the UL grant. If there is no UL grant scheduled to the UE before the UE receives the RRC message to terminate the SDT procedure, the UE may initiate another 4-step RACH procedure or another 2-step RACH procedure for sending the RRC resume request to the NW.

In one aspect, the UE may start a new timer and wait for the next UL transmission opportunity (for the subsequent data transmission) by monitoring the PDCCH addressed to the UE (via a C-RNTI, a TEMPORARY_C-RNTI, a CS-RNTI, and/or a UE-specific SDT-RNTI) while the new timer is still running. If there is a UL grant scheduled to the UE before the new timer expires, the UE may stop the new timer and transmit the new UL DCCH message that is used to inform/report the data arrival from the non-SDT DRB/SRB during the SDT procedure in the UL resource scheduled by the UL grant. If the new timer expires, the UE may initiate another 4-step RACH procedure or another 2-step RACH procedure for sending the RRC resume request or the new DCCH message to the NW. Specifically, the unit of the new timer may be slot, symbol, subframe, system frame, millisecond (ms), etc. The new timer may be configured as 0. The new timer may be started/restarted upon the UE detecting the data arrival from the non-SDT SRB/DRB.

In one aspect, the UE may wait to initiate another 4-step RACH procedure or another 2-step RACH procedure for sending the RRC resume request to the NW after the SDT procedure is terminated (e.g., upon receiving the RRC message to terminate the SDT procedure and/or when the SDT failure detection timer is expired).

In one example, in a case that the UE selects the 2-step RACH as the mechanism to perform the SDT and detects the data arrival from the non-SDT DRB/SRB before the UE has transmitted the first UL message of the SDT procedure in the MSGA PUSCH resource associated with the selected 2-step PRACH resource, the UE may perform at least one of the following actions.

In one action, the UE may cancel/stop/terminate the current 2-step RACH procedure for the SDT, skip the MSGA PUSCH resource (and/or consider the current 2-step RACH procedure unsuccessfully completed), and trigger another 2-step RACH procedure or another 4-step RACH procedure for performing the legacy RRC resume procedure that uses the PRACH resources configured for the normal/legacy RA procedure.

In one action, the UE may transmit the RRC resume request message with the padding bits (without multiplexing the SDT data and/or the BSR MAC CE) as the first UL message of the SDT procedure in the MSGA PUSCH resource associated with the selected 2-step PRACH resource. The padding bits are used by the UE to implicitly inform the NW the data arrival from the non-SDT SRB/DRB. The RRC resume request message may explicitly/implicitly indicate that the UE is performing the legacy RRC resume procedure, via using the existing resume causes in the Rel-16 specification, or via not containing a new IE whose presence implies that the UE is performing an SDT procedure.

In one action, the UE may transmit the RRC resume request message together with a new UL DCCH message that is used to inform/report the data arrival from the non-SDT DRB/SRB during the SDT procedure as the first UL message of the SDT procedure in the MSGA PUSCH resource associated with the selected 2-step PRACH resource.

In one action, the UE may transmit the RRC resume request message as the first UL message via the MSGA PUSCH of a 2-step RA procedure of the SDT procedure. The UE may receive the MSGB to complete the 2-step RA procedure of the SDT procedure and keep performing the SDT procedure. The UE may transmit the UL DCCH message (that is used to inform/report the data arrival from the non-SDT DRB/SRB) via a UL resource dynamically scheduled by the NW during the on-going SDT procedure after the 2-step RA procedure is completed. Alternatively, the UL resource may be scheduled by the MSGB.

In one example, in a case that the UE selects the 2-step RACH as the mechanism to perform the SDT and detects the data arrival from the non-SDT DRB/SRB after the UE has transmitted the first UL message of the SDT procedure in the MSGA PUSCH resource associated with the selected 2-step PRACH resource, the UE may perform at least one of the following actions.

In one action, the UE may cancel/stop/terminate the current SDT procedure, stop monitoring the PDCCH addressed to the UE (via a C-RNTI, a MSGB-RNTI, a CS-RNTI, and/or a UE-specific SDT-RNTI) (and/or consider the current 2-step RACH procedure unsuccessfully completed), and trigger another 4-step RACH procedure or another 2-step RACH procedure for performing the legacy RRC resume procedure that uses the PRACH resource configured for the normal/legacy RA procedure.

In one aspect, the UE may cancel/stop/terminate the current SDT procedure, stop monitoring the PDCCH addressed to the UE (via a C-RNTI, a MSGB-RNTI, a CS-RNTI, and/or a UE-specific SDT-RNTI) (and/or consider the current 2-step RACH procedure unsuccessfully completed), and trigger another 4-step RACH procedure or another 2-step RACH procedure by transmitting the PRACH resource configured for the normal/legacy RA procedure, in order to obtain a UL grant/resource for transmitting the new UL DCCH message that is used to inform/report the data arrival from the non-SDT DRB/SRB during the SDT procedure. In a case that the contention resolution has been resolved (e.g., the UE has received the successRAR including the UE Contention Resolution Identity and/or if the CCCH SDU is included in the MSGA and the UE Contention Resolution Identity in the MAC subPDU matches the CCCH SDU) before the UE cancels/stops/terminates the current SDT procedure, the UE may transmit the new UL DCCH message together with the C-RNTI MAC CE carrying the UE's C-RNTI in the UL grant/resource obtained after triggering another 2-step RACH procedure or another 4-step RACH procedure.

In one aspect, in a case that the contention resolution has been considered successful (e.g., the UE has received the successRAR including the UE Contention Resolution Identity and/or if the CCCH SDU is included in the MSGA and the UE Contention Resolution Identity in the MAC subPDU matches the CCCH SDU) and/or the 2-step RA procedure has been considered successfully completed, the UE may transmit the new UL DCCH message together with the C-RNTI MAC CE carrying the UE's C-RNTI and/or a new MAC CE carrying the UE's full I-RNTI or short I-RNTI in the UL grant/resource obtained after triggering another 4-step RACH procedure or another 2-step RACH procedure.

In one aspect, regardless of whether the contention resolution has been resolved or not (e.g., regardless of whether the UE has received the successRAR including the UE Contention Resolution Identity or not and/or regardless of whether the UE has received the MSGB) upon UE canceling/stopping/terminating the current SDT procedure, the UE may transmit the new UL DCCH message together with a new MAC CE carrying the UE's full I-RNTI or short I-RNTI and/or together with C-RNTI MAC CE carrying the UE's C-RNTI in the UL grant/resource obtained after triggering another 2-step RACH procedure or another 4-step RACH procedure.

In one action, the UE may wait for the next UL transmission opportunity (for the subsequent data transmission) by monitoring the PDCCH addressed to the UE (via a C-RNTI, a MSGB-RNTI, a CS-RNTI, and/or a UE-specific SDT-RNTI) until receiving the RRC message (e.g., an RRC Release message) that terminates the SDT procedure. If there is a UL grant scheduled to the UE before the UE receives the RRC message terminating the SDT procedure, the UE may transmit the new UL DCCH message that is used to inform/report the data arrival from the non-SDT DRB/SRB during the SDT procedure in the UL grant. If there is no UL grant scheduled to the UE before the UE receives the RRC message terminating the SDT procedure, the UE may initiate another 4-step RACH procedure or another 2-step RACH procedure for sending the RRC resume request to the NW.

In one aspect, the UE may start a new timer and wait for the next UL transmission opportunity (for the subsequent data transmission) by monitoring the PDCCH addressed to the UE (via a C-RNTI, a MSGB-RNTI, a CS-RNTI, and/or a UE-specific SDT-RNTI) while the new timer is still running. If there is a UL grant scheduled to the UE before the new timer expires, the UE may stop the new timer and transmit the new UL DCCH message that is used to inform/report the data arrival from the non-SDT DRB/SRB during the SDT procedure in the UL resource scheduled by the UL grant. If the new timer expires, the UE may initiate another 4-step RACH procedure or another 2-step RACH procedure for sending the RRC resume request or the new DCCH message to the NW. Specifically, the unit of the new timer may be slot, symbol, subframe, system frame, ms, etc. The new timer may be configured as 0. The new timer is started/restarted upon the UE detecting the data arrival from the non-SDT SRB/DRB.

In one aspect, the UE may wait to initiate another 4-step RACH procedure or another 2-step RACH procedure for sending the RRC resume request to the NW after the SDT procedure is terminated (e.g., upon receiving the RRC message to terminate the SDT procedure and/or when the SDT failure detection timer is expired).

In one example, in a case that the UE selects the CG type 1 as the mechanism to perform the SDT and detects the data arrival from the non-SDT DRB/SRB regardless of whether the UE has transmitted the first UL message of the SDT procedure in the CG resource, the UE may perform at least one of the following actions.

In one action, the UE may cancel/stop/terminate the current CG procedure for the SDT, stop monitoring the PDCCH addressed to the UE (via a C-RNTI, a CS-RNTI, and/or a UE-specific SDT-RNTI) (and/or consider that the current CG procedure for the SDT is unsuccessfully completed), and trigger another 4-step RACH procedure or another 2-step RACH procedure for performing the legacy RRC resume procedure that uses the PRACH resource configured for the normal/legacy RA procedure.

In one action, the UE may cancel/stop/terminate the current CG procedure for the SDT, stop monitoring the PDCCH addressed to the UE (via a C-RNTI, a CS-RNTI, and/or a UE-specific SDT-RNTI) (and/or consider that the current CG procedure for the SDT is unsuccessfully completed), and trigger another 4-step RACH procedure or another 2-step RACH procedure by transmitting the PRACH resource configured for the normal/legacy RA procedure, in order to obtain a UL grant/resource for transmitting the new UL DCCH message that is used to inform/report the data arrival from the non-SDT DRB/SRB during the SDT procedure.

In one aspect, the UE may transmit the new UL DCCH message together with the C-RNTI MAC CE carrying the UE's C-RNTI, a new MAC CE carrying the UE's CS-RNTI, or a new MAC CE carrying the UE's full I-RNTI or short I-RNTI in the UL grant/resource obtained after triggering another 2-step RACH procedure or another 4-step RACH procedure.

In one aspect, the new UL DCCH message may include the C-RNTI, the CS-RNTI, the full I-RNTI, and/or the short I-RNTI.

In one action, the UE may wait for the next CG resource and/or monitor for the dynamic grant (via monitoring the PDCCH addressed to a C-RNTI, a CS-RNTI, and/or a UE-specific SDT-RNTI) until receiving the RRC message (e.g., an RRC Release message) that terminates the SDT procedure. If there is a UL resource/grant available to the UE before the UE receives the RRC message to terminate the SDT procedure, the UE may transmit the new UL DCCH message that is used to inform/report the data arrival from the non-SDT DRB/SRB during the SDT procedure in the UL resource/grant. If there is no UL resource/grant available to the UE before the UE receives the RRC message to terminate the SDT procedure, the UE may initiate another 4-step RACH procedure or another 2-step RACH procedure for sending the RRC resume request to the NW.

In one aspect, the UE may start a new timer and wait for the next UL transmission opportunity by a CG resource and/or by monitoring the PDCCH addressed to the UE (via a C-RNTI, a CS-RNTI, and/or a UE-specific SDT-RNTI) while the new timer is still running. If there is a UL resource/grant available to the UE before the new timer expires, the UE may stop the new timer and transmit the new UL DCCH message that is used to inform/report the data arrival from the non-SDT DRB/SRB during the SDT procedure in the UL resource/grant. If the new timer expires, UE may initiate another 4-step RACH procedure or another 2-step RACH procedure for sending the RRC resume request or the new DCCH message to the NW. Specifically, the unit of the new timer may be slot, symbol, subframe, system frame, ms, etc. The new timer may be configured as 0. The new timer is started/restarted upon the UE detecting the data arrival from the non-SDT SRB/DRB.

In one aspect, the UE may wait to initiate another 4-step RACH procedure or another 2-step RACH procedure for sending the RRC resume request to the NW after the SDT procedure is terminated (e.g., upon receiving the RRC message to terminate the SDT procedure and/or when SDT failure detection timer is expired).

UE Behavior Upon Receiving the RRC Message after Indicating the Arrival of Non-SDT Data

In some implementations, upon transmitting the new DCCH message indicating the data arrival from the non-SDT DRB/SRB during an SDT procedure, the UE may start/restart the SDT failure detection timer and monitor the PDCCH addressed to a C-RNTI, a TEMPORARY_C-RNTI, a MSGB-RNTI, a CS-RNTI, and/or a UE-specific SDT-RNTI for receiving the RRC message from the NW responding to the new DCCH message.

In one example, the UE may receive an RRCResume message, an RRCRelease message (with or without a suspendConfig), an RRCSetup message, or an RRCReject message from the NW by monitoring the PDCCH addressed to the above-mentioned RNTIs. These RRC messages may be either responding to the earlier RRC resume request message that the UE has sent upon triggering the SDT procedure, or responding to the later DCCH message that the UE has sent to indicate the data arrival from the non-SDT DRB/SRB.

In some implementations, if the UE receives an RRCResume message from the NW after transmitting the new DCCH message indicating the data arrival from the non-SDT DRB/SRB during an SDT procedure, the UE may stop the SDT failure detection timer and transition to the RRC_CONNECTED state based on the configurations provided in the RRCResume message.

In some implementations, if the UE receives an RRCSetup message from the NW after transmitting the new DCCH message indicating the data arrival from the non-SDT DRB/SRB during an SDT procedure, the UE may stop the SDT failure detection timer and perform an RRC establishment procedure with the NW for establishing the RRC connection with the NW.

In some implementations, if the UE receives an RRCReject message from the NW after transmitting the new DCCH message indicating the data arrival from the non-SDT DRB/SRB during an SDT procedure, the UE may stop the SDT failure detection timer and remain in the RRC_INACTIVE state. The UE may not send another RRC resume request or another DCCH message to the NW before a ‘wait time’ (e.g., indicated in the RRCReject message) expires.

In some implementations, if the UE receives an RRCRelease message with or without the a suspendConfig IE from the NW after transmitting the new DCCH message indicating the data arrival from the non-SDT DRB/SRB during an SDT procedure, the UE may perform at least one of the following actions.

In one action, the UE may determine whether to stop the SDT failure detection timer and stop further monitoring the PDCCH addressed to a C-RNTI, a TEMPORARY_C-RNTI, a MSGB-RNTI, a CS-RNTI, and/or a UE-specific SDT-RNTI, based on an explicit indication signaled in the RRCRelease message.

In one aspect, the explicit indication may be a new IE/flag, and the presence of the new IE/flag implies that this RRCRelease is responding to the new DCCH message, and accordingly, the UE may stop the SDT failure detection timer and stop monitoring the PDCCH addressed to a C-RNTI, a TEMPORARY_C-RNTI, a MSGB-RNTI, a CS-RNTI, and/or a UE-specific SDT-RNTI upon receiving the RRCRelease message, and then act accordingly based on the configurations provided in the RRCRelease message.

If UE receives the RRCRelease message that does not include the new IE/flag, the UE may not stop the SDT failure detection timer and may need to continue monitoring the PDCCH addressed to a C-RNTI, a TEMPORARY_C-RNTI, a MSGB-RNTI, a CS-RNTI, and/or a UE-specific SDT-RNTI upon receiving the RRCRelease message. The UE may restart the SDT failure detection timer in this case.

In one action, the UE may determine whether to stop the SDT failure detection timer and stop further monitoring of the PDCCH addressed to a C-RNTI, a TEMPORARY_C-RNTI, a MSGB-RNTI, a CS-RNTI, and/or a UE-specific SDT-RNTI based on the SDT configuration (if any) provided in the RRCRelease message.

In one aspect, if the SDT configuration is different from the previous/stored SDT configuration, and particularly, if the updated SDT configuration allows the UE to transmit the arrived data from the non-SDT DRB/SRB in the RRC_INACTIVE state (e.g., the updated SDT configuration has turned the non-SDT DRB/SRB that the UE detects the data arrival into the SDT DRB/SRB), the UE may determine to stop the SDT failure detection timer and stop further monitoring of the PDCCH addressed to a C-RNTI, a TEMPORARY_C-RNTI, a MSGB-RNTI, a CS-RNTI, and/or a UE-specific SDT-RNTI, and then remain in the RRC_INACTIVE state based on the configuration provided in the RRCRelease message. The UE may initiate another SDT procedure to transmit the data remaining in the UE buffer soon after receiving the RRCRelease message.

In one aspect, if there is no SDT configuration, or if the SDT configuration is the same as the previous/stored SDT configuration, or if the SDT configuration does not allow the UE to transmit the arrived data from the non-SDT DRB/SRB, the UE may determine not to stop the SDT failure detection timer and to continue monitoring the PDCCH addressed to a C-RNTI, a TEMPORARY_C-RNTI, a MSGB-RNTI, a CS-RNTI, and/or a UE-specific SDT-RNTI. The UE may restart the SDT failure detection timer in this case.

In some implementations, if the UE receives an RRCRelease message with or without the a suspendConfig IE from the NW after transmitting the new DCCH message indicating the data arrival from the non-SDT DRB/SRB during an SDT procedure, and if the UE determines not to stop the SDT failure detection timer and continue monitoring the PDCCH addressed to a C-RNTI, a TEMPORARY_C-RNTI, a MSGB-RNTI, a CS-RNTI, and/or a UE-specific SDT-RNTI upon receiving the RRCRelease message, the UE may perform at least one of the following actions.

In one action, the UE may skip/ignore the configurations provided in the RRCRelease message.

In one action, if the UE further receives an RRC message from the NW before the SDT failure detection timer expires, the UE may stop the SDT failure detection timer and stop monitoring the PDCCH addressed to a C-RNTI, a TEMPORARY_C-RNTI, a MSGB-RNTI, a CS-RNTI, and/or a UE-specific SDT-RNTI, and then perform the actions according to the received RRC message.

In one aspect, if the received RRC message is an RRCResume message, the UE may transition to the RRC_CONNECTED state based on the configurations provided in the RRCResume message.

In one aspect, if the received RRC message is an RRCRelease message without the suspendConfig IE, the UE may transition to the RRC_IDLE state based on the configurations provided in the RRCResume message.

In one aspect, if the received RRC message is an RRCRelease message with the suspendConfig IE, the UE may remain in the RRC_INACTIVE state based on the configurations provided in the RRCResume message.

In one action, if the UE doesn't receive any further RRC message from the NW upon the expiry of the SDT failure detection timer, the UE may autonomously transition to the RRC_IDLE state, select/reselect a cell and camp on it, and perform an RRC connection establishment procedure with the NW.

Alternatively, if the UE doesn't receive any further RRC message from the NW upon the expiry of the SDT failure detection timer, the UE may (stay in the RRC_INACTIVE state and) send another RRC resume request message to the NW attempting to resume its RRC connection with the NW. A maximum number of attempting/re-attempting to resume the UE's RRC connection may not exceed a value (e.g., a threshold) that is either configured by the NW or a specified/pre-defined value.

Contention-Free RA Procedure for SDT

In some implementations, in addition to the 2-step CBRA, 4-step CBRA, and CG type 1 resource, the UE may be configured with the 2-step CFRA or 4-step CFRA resource for performing the SDT in the RRC_INACTIVE state. The NW may configure the 2-step CFRA or 4-step CFRA resource for the UE to perform the SDT in the RRC_INACTIVE state, in order to improve the following situations/scenarios/examples.

In one example, in a case that the UE may frequently trigger the SDT but the traffic pattern is not predictable or the traffic always comes in a burst (e.g., not the constant bit rate type).

In one example, in a case that the NW knows that UE may soon trigger another RACH for performing the SDT or the RRC resume procedure while terminating the current SDT procedure (this is possible if the NW prefers to prioritize the transmission for the RRC message over the user data transmission, or if the NW is aware of the non-SDT traffic arrival at the UE side in the middle of the SDT procedure).

In one example, in a case that the UE is configured to report its location information in the RRC_INACTIVE state on a regular basis.

In one example, to allow the gNB to identify the UE in a more efficient manner in a case that the UE prefers to trigger an RA procedure for transmitting the new DCCH message indicating the arrival of non-SDT traffic.

In some implementations, the NW may configure the 2-step CFRA or 4-step CFRA resources for the SDT operation to the UE via the RRCRelease message upon the UE entering into the RRC_INACTIVE state or when the NW terminates an SDT procedure. Specifically, the CFRA resources for the SDT operation may be configured within the SDT-Config-r17 IE of the suspendConfig IE in the RRCRelease message, as shown in Table 2.

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |
| ran-NotificationAreaInfo | RAN-NotificationAreaInfo |
| t380 | PeriodicRNAU-TimerValue |
| nextHopChainingCount | NextHopChainingCount, |
| ..., | |
| [[ | |
| -- SDT specific configuration | |
| Sdt-Config-r17 | SDT-Config-r17 |
| ]] | |
| } | |
| SDT-Config-r17 ::= | SEQUENCE { |
| std-DRBList | SEQUENCE (SIZE (1..maxDRB)) OF DRB-Identity, |
| std-SRB2Indication | ENUMERATED {allowed}, |
| cg-SDT-Config | SetupRelease {CG-SDT-Config}, |
| t3xx | ENUMERATED {ms50, ms100, ms200, ms500, ms1000, ms10000}, |
| cfra-scope | ENUMERATED {cell-specific, rna-specific, ta-specific}, |
| cfra-SDT | RACH-ConfigDedicated |
| } | |
| RACH-ConfigDedicated ::= | SEQUENCE { |
| cfra | CFRA |
| ra-Prioritization | RA-Prioritization |
| ..., | |
| [[ | |
| ra-PrioritizationTwoStep-r16 | RA-Prioritization |
| cfra-TwoStep-r16 | CFRA-TwoStep-r16 |
| ]] | |
| } | |
| CFRA ::= | SEQUENCE { |
| occasions | SEQUENCE { |
| rach-ConfigGeneric | RACH-ConfigGeneric, |
| ssb-perRACH-Occasion | ENUMERATED {oneEighth, oneFourth, oneHalf, one, two, |
| | four, eight, |
| sixteen} | |
| } | |
| resources | CHOICE { |
| ssb | SEQUENCE { |
| ssb-ResourceList | SEQUENCE (SIZE(1..maxRA-SSB-Resources)) OF CFRA- |
| | SSB-Resource, |
| ra-ssb-OccasionMaskIndex | INTEGER (0..15) |
| }, | |
| csirs | SEQUENCE { |
| csirs-ResourceList | SEQUENCE (SIZE(1..maxRA-CSIRS-Resources)) OF |
| | CFRA-CSIRS-Resource, |
| rsrp-ThresholdCSI-RS | RSRP-Range |
| } | |
| }, | |
| ..., | |
| [[ | |

totalNumberOfRA-Preambles INTEGER (1..63)

| | |
|---|---|
| ]] | |
| } | |
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, |
| | one, two, four, eight, sixteen} |
| } | |
| msgA-CFRA-PUSCH-r16 | MsgA-PUSCH-Resource-r16, |
| msgA-TransMax-r16 | ENUMERATED {n1, n2, n4, n6, n8, n10, n20, n50, |
| | n100, n200} |
| resourcesTwoStep-r16 | SEQUENCE { |
| ssb-ResourceList | SEQUENCE (SIZE(1..maxRA-SSB-Resources)) OF |
| | CFRA-SSB-Resource, |
| ra-ssb-OccasionMaskIndex | INTEGER (0..15) |
| }, | |
| ... | |
| } | |
| CFRA-SSB-Resource ::= | SEQUENCE { |
| ssb | SSB-Index, |
| ra-PreambleIndex | INTEGER (0..63), |
| ..., | |
| [[ | |
| msgA-PUSCH-Resource-Index-r16 | INTEGER (0..3071) |
| ]] | |
| } | |
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER |
| | (0..maxRA-Occasions-1), |
| ra-PreambleIndex | INTEGER (0..63), |
| ... | |
| } | |

In one example, within the SDT-Config-r17 IE, a timer t3xx is a new timer used to regulate the valid duration during which the configured CFRA resources are valid/available for the UE to trigger the SDT procedure. The timer t3xx may start upon the UE receiving the RRCRelease message and stop upon the UE leaving the coverage area where the CFRA resources are configured to the UE. If the timer t3xx expires or is not running, the UE is not allowed to use the CFRA resources configured in the SDT-Config-r17 IE.

In one example, within the SDT-Config-r17 IE, an area scope cfra-scope defines the area scope where the CFRA resources are configured and available to the UE. Specifically, the area scope cfra-scope may refer to the coverage area of the serving cell, the coverage area of the UE's registered RNA, the coverage area of the UE's registered TA, or the coverage area of the UE's registered PLMN.

In one example, within the SDT-Config-r17 IE, a configuration cfra-SDT includes configurations with regard to the CFRA resources (e.g., PRACH occasions and/or preambles) assigned to the UE, and reuses the RACH-ConfigDedicated IE.

In one example, the NW may broadcast in the SI (e.g., a SIB1) a new indication instructing UEs whether their configured CFRA resources for the SDT operation are activated or de-activated.

In one aspect, in a case that the indication indicates all the CFRA resources for the SDT operation are de-activated, the UEs that are configured with the CFRA resources for the SDT operation may not use the CFRA resources, and the UEs that are configured with the new timer t3xx may suspend/pause the new timer.

In one aspect, in a case that the indication indicates all the CFRA resources for the SDT operation are activated, the UEs that are configured with the CFRA resources for the SDT operation may use the CFRA resources, and the UEs that are configured with the new timer t3xx may resume the new timer if the new timer had been suspended/paused earlier.

In one example, whenever the UE triggers the RA-SDT using the CFRA resources, the UE may send the user data, the DCCH message used to indicate the arrival of non-SDT data (e.g., a non-SDT data indication), the BSR MAC CE, and/or the UE assistance information (e.g., via a UL-DCCH-MessageType IE) to the NW without sending together the RRC resume request message to the NW, where the NW may be able to identify the UE via the CFRA resource used by the UE.

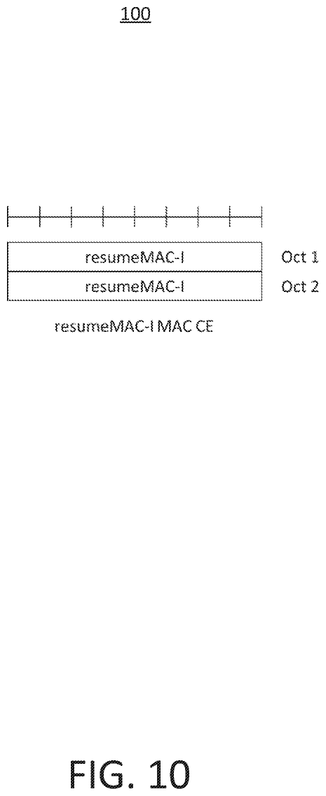

Please refer to FIG. 10, which illustrates a diagram 100 of a resumeMAC-I MAC CE, according to an example implementation of the present disclosure. In one aspect, the UE may further transmit a new MAC CE including the resumeMAC-I calculated by the UE, together with the user data, the DCCH message used to indicate the arrival of non-SDT data, the BSR MAC CE, and/or the UE assistance information to the NW, in a case that the UE does not send the RRC resume request message to the NW in the RA-SDT procedure.

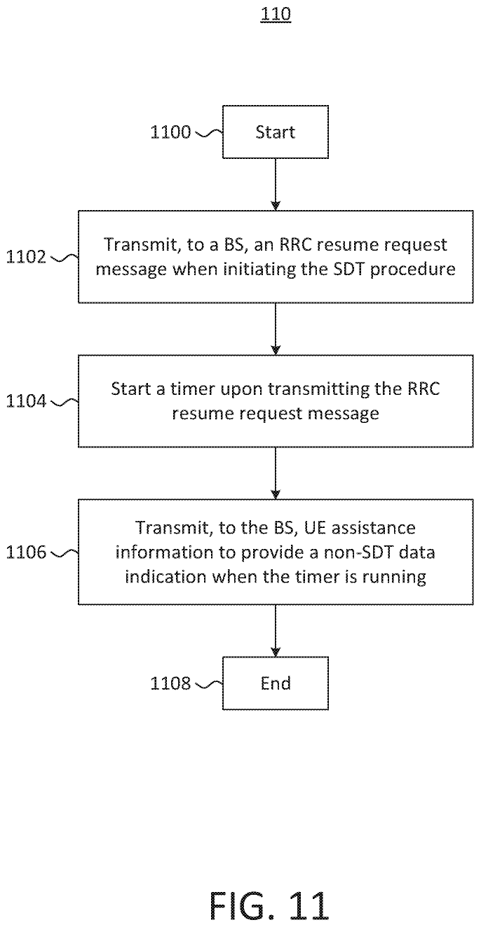

FIG. 11 illustrates a flowchart of a procedure 110 performed by a UE for the SDT procedure, according to an example implementation of the present disclosure. In some implementations, actions of the procedure 110 are illustrated as separate actions represented as independent blocks. In some other implementations, these separate actions may not be construed as necessarily order-dependent, where any two or more actions may also be performed and/or combined with each other or be integrated with other alternate methods, which does not limit the scope of the implementation. Moreover, in some other implementations, one or more of the actions may be adaptively omitted.

As shown in FIG. 11, the procedure 110 for the UE includes the following actions:

Action 1100: Start.

Action 1102: Transmit, to a BS, an RRC resume request message when initiating the SDT procedure.

Action 1104: Start a timer upon transmitting the RRC resume request message.

Action 1106: Transmit, to the BS, UE assistance information to provide a non-SDT data indication when the timer is running.

Action 1108: End.

In some implementations, in action 1102, the UE may transmit the RRC resume request message to the BS when initiating the SDT procedure. In action 1104, the UE may start the timer upon transmitting the RRC resume request message. In some implementations, the timer is a T319a timer.

In action 1106, the UE may transmit the UE assistance information to the BS to provide the non-SDT data indication when the timer is running. In some implementations, the UE assistance information is included in a UL-DCCH-MessageType IE. In some implementations, the non-SDT data indication is included in the UE assistance information. In some implementations, the SDT procedure is initiated by the UE when the UE is in the RRC_INACTIVE state.

In some implementations, the procedure 110 may further configure the UE to stop the timer upon reception of an RRC resume message. In some implementations, the procedure 110 may further configure the UE to stop the timer upon reception of an RRC setup message. In some implementations, the procedure 110 may further configure the UE to stop the timer upon reception of an RRC reject message.

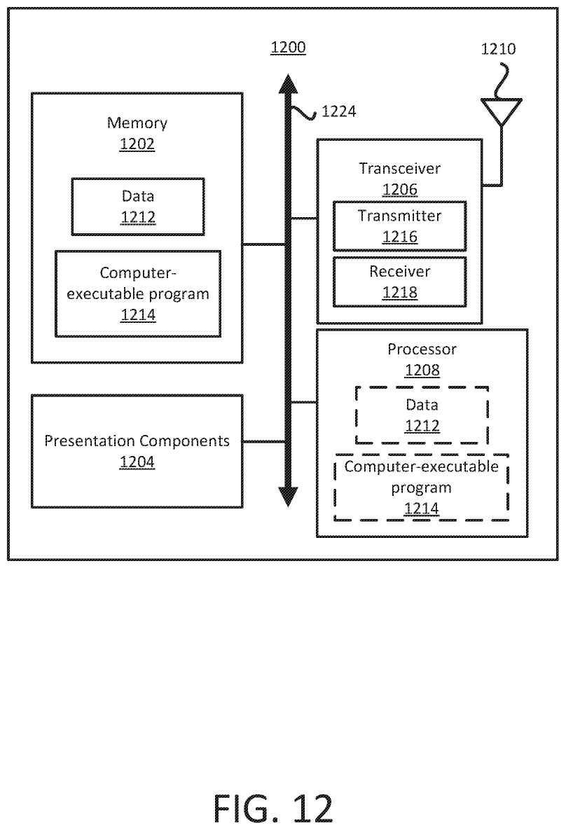

Please refer to FIG. 12, which illustrates a block diagram of a node 1200 for wireless communication according to an implementation of the present disclosure. As illustrated in FIG. 12, the node 1200 includes a transceiver 1206, a processor 1208, a memory 1202, one or more presentation components 1204, and at least one antenna 1210. The node 1200 may also include a Radio Frequency (RF) spectrum band module, a BS communications module, an NW communications module, and a system communications management module, input/output (I/O) ports, I/O components, and power supply (not explicitly illustrated in FIG. 12). Each of these components may be in communication with each other, directly or indirectly, over one or more buses 1224. The node 1200 may be a UE, an NW, a cell/BS or any operating entity in the wireless communication system that performs various functions disclosed herein, for example, with reference to FIG. 11.

The transceiver 1206 includes a transmitter 1216 (e.g., transmitting/transmission circuitry) and a receiver 1218 (e.g., receiving/reception circuitry) and may be configured to transmit and/or receive time and/or frequency resource partitioning information. The transceiver 1206 may be configured to transmit in different types of subframes and slots, including, but not limited to, usable, non-usable, and flexibly usable subframes and slot formats. The transceiver 1206 may be configured to receive data and control channels.

The node 1200 may include a variety of computer-readable media. Computer-readable media may be any available media that may be accessed by the node 1200 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information, such as computer-readable information.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal, such as a carrier wave, or other transport mechanism and include any information delivery media.

The term “modulated data signal” may refer to a signal that has one or more of its characteristics set or changed in such a manner as to encode information in the signal. By way of example, and not limitation, communication media may include wired media, such as a wired NW or direct-wired connection, and wireless media, such as acoustic, RF, infrared, and other wireless media. Combinations of any of the previous disclosure should also be included within the scope of computer-readable media.

The memory 1202 may include computer-storage media in the form of volatile and/or non-volatile memory. The memory 1202 may be removable, non-removable, or a combination thereof. For example, the memory 1202 may include solid-state memory, hard drives, optical-disc drives, etc.

As illustrated in FIG. 12, the memory 1202 may store a computer-executable (or readable) program 1214 (e.g., software codes or instructions) that are configured to, when executed, cause the processor 1208 to perform various functions disclosed herein, for example, with reference to FIG. 11. Alternatively, the computer-executable program 1214 may not be directly executable by the processor 1208 but may be configured to cause the node 1200 (e.g., when compiled and executed) to perform various functions disclosed herein.

The processor 1208 (e.g., having processing circuitry) may include an intelligent hardware device, a CPU, a microcontroller, an ASIC, etc. The processor 1208 may include memory. The processor 1208 may process the data 1212 and the computer-executable program 1214 received from the memory 1202, and information received via the transceiver 1206, the baseband communications module, and/or the NW communications module. The processor 1208 may also process information to be sent to the transceiver 1206 for transmission through the antenna 1210 to the NW communications module for subsequent transmission to a CN.

One or more presentation components 1204 may present data to a person or other device. Examples of presentation components 1204 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

What is claimed is:

1. A method performed by a User Equipment (UE) for a Small Data Transmission (SDT) procedure, the method comprising:
transmitting, to a Base Station (BS), a Radio Resource Control (RRC) resume request message when initiating the SDT procedure;
starting a timer upon transmitting the RRC resume request message; and
transmitting, to the BS, UE assistance information to provide a non-SDT data indication when the timer is running.

2. The method of claim 1, wherein the timer is a T319a timer.

3. The method of claim 1, further comprising:
stopping the timer upon reception of an RRC resume message.

4. The method of claim 1, further comprising:
stopping the timer upon reception of an RRC setup message.

5. The method of claim 1, further comprising:
stopping the timer upon reception of an RRC reject message.

6. The method of claim 1, wherein the UE assistance information is included in a UL-DCCH-MessageType Information Element (IE).

7. The method of claim 1, wherein the non-SDT data indication is included in the UE assistance information.

8. The method of claim 1, wherein the SDT procedure is initiated, by the UE, when the UE is in an RRC_INACTIVE state.

9. A User Equipment (UE) in a wireless communication system for performing a Small Data Transmission (SDT) procedure, the UE comprising:
at least one processor; and
at least one memory coupled to the at least one processor, wherein the at least one memory stores a computer-executable program that, when executed by the at least one processor, causes the UE to:
transmit, to a Base Station (BS), a Radio Resource Control (RRC) resume request message when initiating the SDT procedure;
start a timer upon transmitting the RRC resume request message; and
transmit, to the BS, UE assistance information to provide a non-SDT data indication when the timer is running.

10. The UE of claim 9, wherein the timer is a T319a timer.

11. The UE of claim 9, wherein the computer-executable program, when executed by the at least one processor, further causes the UE to:
stop the timer upon reception of an RRC resume message.

12. The UE of claim 9, wherein the computer-executable program, when executed by the at least one processor, further causes the UE to:
stop the timer upon reception of an RRC setup message.

13. The UE of claim 9, wherein the computer-executable program, when executed by the at least one processor, further causes the UE to:
stop the timer upon reception of an RRC reject message.

14. The UE of claim 9, wherein the UE assistance information is included in a UL-DCCH-MessageType Information Element (IE).

15. The UE of claim 9, wherein the non-SDT data indication is included in the UE assistance information.

16. The UE of claim 9, wherein the SDT procedure is initiated, by the UE, when the UE is in an RRC_INACTIVE state.
